(19) United States
(12) Patent Application Publication
(10) Pub. No.: US 2025/0299344 A1
(43) Pub. Date: Sep. 25, 2025

(54) ROAD LONGITUDINAL SLOPE ESTIMATION METHOD BASED ON UNMANNED AERIAL VEHICLE AERIAL PHOTOGRAPHY VIDEO

(71) Applicant: Hefei University of Technology, Hefei (CN)

(72) Inventors: Kai YUAN, Hefei (CN); Yifei CHE, Hefei (CN); Liyang WEI, Hefei (CN)

(73) Assignee: Hefei University of Technology, Hefei (CN)

(21) Appl. No.: 19/037,341

(22) Filed: Jan. 27, 2025

(30) Foreign Application Priority Data
Mar. 19, 2024 (CN) 202410315361.9

(51) Int. Cl. G06T 7/215; G06T 5/60; G06T 5/70; G06T 7/246; G06T 7/262; G06T 7/60

(52) U.S. Cl. CPC G06T 7/215; G06T 5/60; G06T 5/70; G06T 7/248; G06T 7/262; G06T 7/60; G06T 2207/10016; G06T 2207/10032; G06T 2207/20076; G06T 2207/20081; G06T 2207/30236; G06T 2207/30241

(57) ABSTRACT

A road longitudinal slope estimation method based on unmanned aerial vehicle aerial photography video includes: collecting and correcting the traffic flow video of the road; taking the center line of the road as the reference line, extracting pixels on the reference line, and outputting the pixel gray space-time image on the reference line; performing the contour extraction of pixel gray space-time image; through the trajectory contour information, obtaining the complete trajectory data set; identifying the vehicle speed change point by using the energy distribution of wavelet transform; constructing the data set of road slope estimation, and based on the assumption of the actual length distribution of road pixels and the value of road longitudinal slope, applying a Bayesian network and a machine learning algorithm to iteratively obtain an expected value and variance of the actual length of the road pixel point and an estimated value of the road longitudinal slope.

### CROSS REFERENCE TO THE RELATED APPLICATIONS

This application is based upon and claims priority to Chinese Patent Application No. 202410315361.9, filed on Mar. 19, 2024, the entire contents of which are incorporated herein by reference.

### TECHNICAL FIELD

The present invention relates to a road longitudinal slope estimation method based on unmanned aerial vehicle aerial photography video, which belongs to the field of intelligent transportation technology.

### BACKGROUND

The longitudinal slope of the road is a common traffic bottleneck, exploration of the congestion mechanism and control strategy on the longitudinal slope section is one of the important contents to alleviate traffic congestion. In order to study the congestion mechanism on the road longitudinal slope, it is necessary to obtain the road longitudinal slope data. The existing longitudinal slope estimation methods include estimating vehicle mass and slope based on the vehicle longitudinal dynamics model and estimating slope through sensors. However, due to the limitation of experimental devices, the estimation of the longitudinal slope has the problem of high cost of device and manpower.

The existing slope identification methods are:

1, estimating the road slope by using Global Position System (GPS) elevation information, determining the road slope by calculating the height difference, it has high accuracy, but the precision of GPS requirements is relatively high, and the stability is affected by GPS signals;

2, estimating road slope by using Controller Area Network (CAN) bus information and driving equation, mainly using vehicle CAN bus to collect engine driving information, vehicle speed and other information without additional sensor information, Robert proposed a new data fusion algorithm based on the nonlinear adaptive observer, and data fusion is used as part of the extended regression, while the data fusion algorithm structure generates good road slope estimation, a relatively undisturbed and noise-free vehicle mass estimation is provided (WRAGGE-MORLEY R, HERRMANN G, BARBER P, et al. Gradient and Mass Estimation from CAN Based Data for a light passenger Car [J].) 2015,8 (2015-01-0201): 137-45.), however, firstly, the precision provided by the CAN bus is limited, the required device is high, and the cost is expensive; secondly, the vehicle parameters will change with the vehicle condition and environment;

3, estimating the road slope by adding additional sensors, Sahlholm added GPS data to the vehicle parameter estimation, and the estimation method based on the Kalman filter and extended Kalman filter (EKF) (SAHLHOLM P, JOHANSSON K H J C E P. Road grade estimation for look-ahead vehicle control using multiple measurement runs [J]0.2010,18 (11): 1328-41.) is used, wherein the disadvantage is that the information of the change rate of the road slope itself is ignored, particularly when the slope change rate is large, the estimation results will show a more serious delay.

### SUMMARY

In order to overcome the shortcomings of the existing technology, the present invention proposes a road longitudinal slope estimation method based on unmanned aerial vehicle aerial photography video, in order to quickly obtain the trajectory and the distribution information of the headway of the traffic flow, so that the actual length of the road and the longitudinal slope of the road can be calculated according to the distribution, which reduces the requirements of manual and experimental device.

In order to achieve the above objective, the present invention adopts the following technical scheme.

Compared with the existing technology, the beneficial effects of the present invention are:

1. in the acquisition of trajectory data, the center line of the road is used as the reference line, and the pixel splicing on the reference line is called the trajectory map, and the image processing method is used to set the relevant vehicle distance and time interval, vehicle length and other thresholds, and the background and trajectory are separated from the trajectory map. This method can quickly obtain the trajectory data of the vehicle, overcome the problems of conventional manual acquisition of trajectory and the need for special device and a large amount of data, omit the process of manual labeling of deep learning, and ensure a certain precision at the same time.

2. The present invention constructs the relationship between the actual length distribution of video pixels, the reaction time between vehicles and the distribution of vehicle distance through the Bayesian network model, which can obtain the actual length distribution of road pixels, construct the relationship between the actual length of pixels and the road slope value, thereby estimating the slope value. The method overcomes the problem of estimating road slope through complex CAN bus data, improves the running speed, and ensures that the error is within 10%.

### BRIEF DESCRIPTION OF THE DRAWINGS

FIG. 1 is a flow chart of obtaining a complete trajectory of the present invention;

FIG. 2 is a flow chart of a slope calculation of the present invention.

### DETAILED DESCRIPTION OF THE EMBODIMENTS

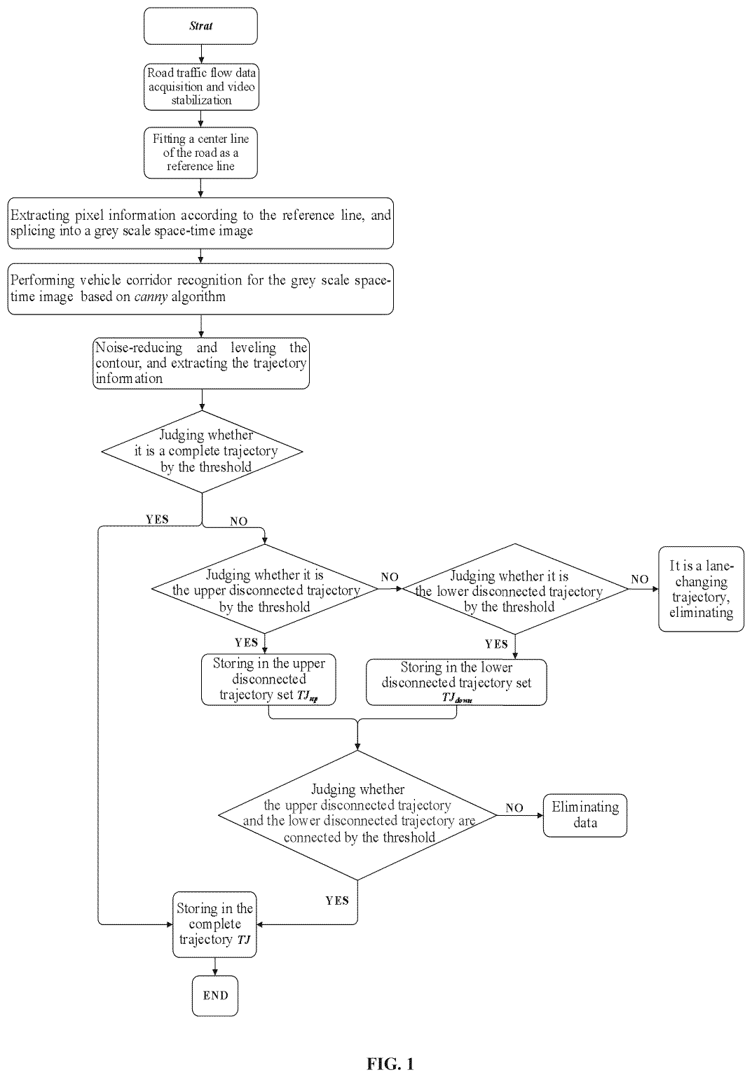

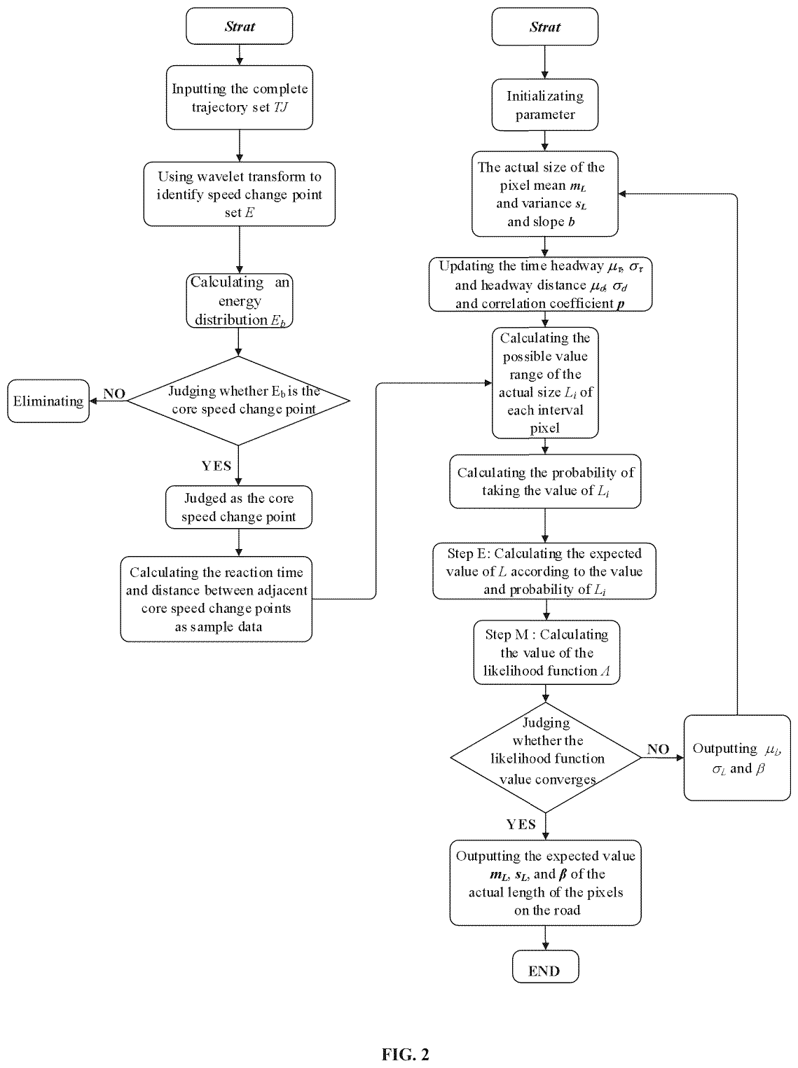

In this embodiment, a road longitudinal slope estimation method based on unmanned aerial vehicle aerial photography video uses the trajectory data extraction flow chart shown in FIG. 1 to extract the slope estimation method in FIG. 2, the Wulidun overpass road in Hefei City, Anhui Province is taken as an example, it is carried out according to the following steps:
step 1, a camera lens on the unmanned aerial vehicle is placed perpendicular to the road horizontal plane so as to shoot a traffic flow video of a road via the unmanned aerial vehicle;
step 2, the traffic flow video is corrected;
step 2.1, a static object recognition is performed on a first frame of picture and the last frame of the picture in the traffic flow video respectively, and two frame recognition results are obtained and performed a static object matching to obtain a static feature template key; let a total number of frames of the traffic flow video be M;
step 2.2, a number of current frames is defined as r, and initialized r=1;
step 2.3, a Fast Library for Approximate Nearest Neighbors (FLANN) algorithm is used to match an m^{th} frame picture in the traffic flow video with the static feature template key to obtain an m^{th} matched feature point set keyₘ, and equation (1) is used to obtain an m^{th} perspective transformation matrix Hₘ;

$$key = {H}_{m} \times {key}_{m} \qquad ( 1 )$$

step 2.4, the m^{th} frame picture is corrected with Hᵣ to obtain a corrected m^{th} frame picture;
step 2.5, m+1 is assigned to r, and judged whether m≤M is valid, and if m≤M is valid, returned to step 2.3 for sequential execution; otherwise, it denotes the corrected traffic flow video;
step 3, a traffic lane J of a maximum traffic volume of a road is determined in the corrected traffic flow video, and a pixel point on a center line of the traffic lane J of a certain frame of the picture in the corrected traffic flow video is fitted by using a polynomial curve, and a reference line is obtained;
a pixel point on the reference line of each frame of the picture in the corrected traffic flow video is extracted, and grouped in a time dimension ϕ to obtain a traffic lane center line picture with an actual length of the road as a space dimension Z and converting the traffic lane center line picture into a grey scale image I;
step 4, a trajectory profile is extracted from the grey scale image I;
step 4.1, a vehicle trajectory in the grey scale image/is acquired via a Canny edge detection algorithm, and after separating the vehicle trajectory from a background, a binary image A is obtained, and let a set of pixel points with a numerical value of 1 in the binary image A constitute a foreground image B;
step 4.2, after performing corrosion and expansion operations on the foreground image B, a processed foreground image B₂ is obtained, and combined the processed foreground image B₂ with the binary image A to form a new binary image A₁;
step 4.3, boundary points of the vehicle trajectory in the binary image A₁ are connected by using an eight-connection criterion to form a processed binary image A₂;
step 4.4, the binary image A₂ is filtered by using an exponential averaging filter to obtain a noise-reduced binary image A₃;
step 4.5, the boundary points of the vehicle trajectory in the binary image A₃ are separated according to a set time threshold value threshold₁, vehicle length threshold value threshold₂ and vehicle headway threshold value threshold₃, so as to obtain contour lines of different vehicles in the binary image A₃, wherein the threshold can take different values according to different videos;
step 4.6, the contour lines of different vehicles in the binary image A₃ are analyzed accurately to obtain the foreground contour of the vehicle as the trajectory data, and according to the entrance and exit order of the vehicles, the trajectory data is sorted in an ascending order to obtain the trajectory data set TJ of the vehicle;
step 5, the trajectory data set TJ is processed to obtain a complete vehicle trajectory data set TJ′;
step 5.1, a distance D₁ between a starting point of the trajectory TJ_{c} of vehicles c and a starting point of the road, and a distance D₂ between an end point of the trajectory TJ_{c} of vehicles c and an end point of the road are calculated;
step 5.2, threshold₄₌₅₀ is set, judged whether D₁≤threshold is valid, if D₁≤threshold₄ is valid, processed to step 5.3; otherwise, the trajectory TJ_{c} of the vehicle C is added to a lower boundary disconnected trajectory TJ_{down}; wherein, threshold₄ denotes a distance threshold between the starting point of the trajectory of vehicles c and the starting point of the road;
step 5.3, thresholds=45 is set, judged whether D₂≤thresholds is valid, if D₂≤thresholds is valid, it indicates that the trajectory TJ_{c} of the vehicle c is a complete trajectory and storing in the complete trajectory set TJ′; otherwise, the trajectory TJ_{c} of the vehicle c is added to an upper boundary disconnected trajectory TJw, where, threshold₄ denotes a distance threshold between the end point of the trajectory of the vehicle c and the end point of the road;
step 5.4, the trajectories of different vehicles in the binary image A₃ are processed according to the process of steps 5.1-5.3, so as to obtain the final lower boundary disconnected trajectory TJ_{down} and the upper boundary disconnected trajectory TJ up;
step 5.5, a difference D₃ between the end point of the trajectory of any lower boundary disconnected trajectory TJ_{down} and the starting point of the trajectory of any upper boundary disconnected trajectory TJᵤₚ in the time dimension ϕ, and a difference D₄ between the end point of the trajectory of the lower boundary disconnected trajectory TJ dow and the starting point of the trajectory of any upper boundary disconnected trajectory TJ″, in the space dimension Z are calculated;
step 5.6, threshold₆₌₁₀₀ and threshold₆₌₃₅₀ are set, judged whether D₃≤threshold₆ and D₄≤threshold, are valid at the same time, if D₃≤threshold, and D₄≤threshold, are valid at the same time, then entering step 5.7; otherwise, it indicates that the trajectory TJ_{c} of the vehicle c is a lane-changing trajectory, and is not stored in the complete trajectory set TJ′, where, threshold, denotes a time headway threshold of the lower boundary disconnected trajectory and the upper boundary disconnected trajectory, and threshold, denotes a space threshold of the lower boundary disconnected trajectory and the upper boundary disconnected trajectory;
step 5.7, a starting point P₀ of the lower boundary disconnected trajectory TJ dow with the missing time series in the middle of an end point P of the upper boundary disconnected trajectory TJᵤₚ are connected by using a first-order Bessel curve as Equation (2) to obtain a missing trajectory TJ₁, and the upper boundary disconnected trajectory TJ″ and the lower boundary disconnected trajectory TJ_{down} are connected to form the complete trajectory TJ_{c} of the vehicle c, and stored in the complete trajectory set TJ′;

$$B ( 𝓏 ) = ( 1 - 𝓏 ) {P}_{0} + 𝓏 {P}_{1} \qquad ( 2 )$$

where, z is the time series between the starting position P₀ of lower boundary disconnected trajectory TJ_{down} and the end position P of the upper boundary disconnected trajectory TJᵤₚ, and B(z) is the complementary position function of the missing trajectory B(z);
step 5.8, the complete trajectory set TJ′ is sorted in ascending order according to the order of the trajectory, a sorted complete trajectory set TJ₂ is obtained, and any j^{th} complete trajectory in the complete trajectory set TJ₂ is recorded as trajectoryⱼ=[x], where, t, is a time series of a j^{th} complete trajectory in the time dimension @, and x, is a position series of the j^{th} complete trajectory in the space dimension Z;
step 6, according to TJ₂, a core speed change point set E of all the complete trajectories is acquired by using a wavelet transform;
step 6.1, an approximate coefficient Tⱼ(a,b) of the j^{th} complete trajectory in the complete trajectory set TJ′ is calculated by Equation (3);

$${T}_{j} ( a , b ) = \frac{1}{\sqrt{a}} {\int }_{- ∞}^{∞} {trajectory}_{j} \times [ 1 - {( \frac{{t}_{j} - b}{a} )}^{2} ] {e}^{- \frac{{( \frac{{t}_{j} - b}{a} )}^{2}}{2}} d t \qquad ( 3 )$$

in Equation (3), a is a scale factor, b is a translation factor, b∈tⱼ;
step 6.2, an energy distribution Eⱼ is calculated by Equation (4);

$${{E}_{j} = \frac{1}{max ( a )} {\int }_{{a}_{min}}^{{a}_{max}} \vert T ( a , b ) \vert}^{2} da \qquad ( 4 )$$

in Equation (4), aₘᵢₙ denotes a minimum value of the scale factor, the value is 1, aₘₐₓ denotes the maximum value of the scale factor, the value is 64;

$$\frac{\partial {E}_{j}}{\partial b} = 0$$

step 6.3, is calculated, a set of speed change point time β={b₁,b₂, . . . ,b₁, . . . ,b_{R}}
is obtained, where, bᵢ denotes an i^{th} speed change point time, R is a number of speed change points;
step 6.4, a corresponding speed change point under the condition meets max E_{b}|β={b₁,b₂, . . . , bᵢ} is taken as the core speed change point, so as to obtain the time by and position x, corresponding to the core speed change point, and [c, b_{η}, x_{η}] is stored to core speed change point set E;
step 6.5, all the complete trajectories are processed according to the process of steps 6.1-6.4, and the core speed change point set E is obtained;
step 6.6, according to the position of the core speed change point, the core speed change points located on an upper road section are combined into a core speed change point set of the upper road section Eᵤₚ, and the core speed change points located on a lower road section are combined into a core speed change point set of the lower road section E_{down};
step 7, an actual length of the road pixel point and a road longitudinal slope value are assumed, a distribution of a speed change point distance and a reaction time are obtained, a Bayesian network and a machine learning algorithm are applied to iteratively obtain an expected value and variance of the actual length of the road pixel point and an estimated value of the road longitudinal slope;
step 7.1, Equation (5) is used to calculate a reaction time τⱼ between a jᵤₚ^{th} core speed change point and a jᵤₚ+1^{th} core speed change point in the data set of the upper road section Eᵤₚ, so as to obtain a reaction time set τᵤₚ between all adjacent two core speed change points in the data set of the upper road section Eᵤₚ;

$${τ}_{{j}_{up}} = \vert {t}_{{j}_{up} + 1} - {t}_{{j}_{up}} \vert / fps , {t}_{{j}_{up}} ∈ {E}_{up} \qquad ( 5 )$$

in Equation (5), fps denotes a frame rate of the video;
Equation (6) is used to calculate a distance pixel number dⱼ_{ᵤₚ} between the j^{th} core speed change point and the jᵤₚ+1^{th} core speed change point in the data set of the upper road section Eᵤₚ, so as to obtain a distance pixel number set du between all adjacent two core speed change points in the data set of the upper road section Eᵤₚ;

$${d}_{{j}_{up}} = \vert {x}_{{j}_{up} + 1} - {x}_{{j}_{up}} \vert , {x}_{{j}_{up}} ∈ {E}_{up} \qquad ( 6 )$$

Equation (7) is used to calculate a reaction time Tⱼ_{_{down}} between a j_{down}^{th} core speed change point and a jᵤₚ+1^{th} core speed change point in the data set of the lower road section E_{down}, so as to obtain a reaction time set Tdown between all adjacent two core speed change points in the data set of the lower road section E_{down}.

$${τ}_{{j}_{down}} = \vert {t}_{{j}_{down} + 1} - {t}_{{j}_{down}} \vert / fps , {t}_{{j}_{down}} ∈ {E}_{down} \qquad ( 7 )$$

Equation (8) is used to calculate a distance pixel number dⱼ_{_{down}} between a j_{down}^{th} core speed change point and a jᵤₚ+1^{th} core speed change point in the data set of the lower road section E_{down}, so as to obtain a distance pixel number set d down between all adjacent two core speed change points in the data set of the lower road section E_{down};

$${d}_{{j}_{down}} = \vert {x}_{{j}_{down} + 1} - {x}_{{j}_{down}} \vert , {x}_{{j}_{down}} ∈ {E}_{d o w n} \qquad ( 8 )$$

τᵤₚ and τ_{down} are combined into a time sample data set T, and a mean value of the time sample data set T is recorded as μᵣ, and a standard deviation of the time sample data set T is recorded as σ_{τ};
dᵤₚ and d_{down} are combined into a distance pixel number sample data set Dis;
step 7.2, the initial maximum number of iterations is K=10000, an error is gap=10⁻¹⁵, a current number of iterations k=1 is initialized, the actual length L of the road pixel in a k^{th} iteration follows the mean of the actual length of the road pixel is μ_{L}^{(k)}, a standard deviation of the actual length of the road pixel in the k^{th} iteration is a normal distribution N_{L}˜(μ_{L}^{(k)}, σ_{L}^{(k)}) of σ_{L}^{(k)}, and an estimated value λ^{(k)} of the road longitudinal slope in the k^{th} iteration, and an objective function value in the k^{th} iteration is ϑ^{(k)} and ϑ^{(k)} is 10000;
step 7.3, Equation (9), Equation (10) and Equation (11) are used to respectively obtain a mean value μₛ^{(k)} of the actual headway distance in the k^{th} iteration, a standard deviation (k) of the actual headway distance in the k^{th} iteration and a covariance ρ^{(k)} in the k^{th} iteration, so as to obtain relevant parameters (μₛ^{(k)}, σₛ^{(k)}, ρ^{(k)}) of the reaction time τ between the core speed change points and the actual headway distance s obeying a bivariate normal distribution N_{(τ,s)} in the k^{th} iteration;

$${μ}_{s}^{( k )} = \frac{\begin{matrix}{\sum }_{{j}_{up} = 1}^{n} {μ}_{L}^{{( k )}_{*}} {d}_{{j}_{up}}^{( k )} ⋆ ( cos ( {λ}^{( k )} ) + \frac{sin {λ}^{( k )}}{tan ( φ - {λ}^{( k )} )} ) + \\ {\sum }_{{j}_{down} = 1}^{m} {μ}_{L}^{( k )} ⋆ {d}_{down}^{( k )} ⋆ ( \frac{sin φ}{sin ( {λ}^{( k )} + φ )} )\end{matrix}}{n + m - 1} \qquad ( 9 )$$

$${σ}_{s}^{( k )} = \frac{\begin{matrix}\sqrt{{\sum }_{{j}_{up} = 1}^{n} {( {μ}_{L}^{( k )} {d}_{up} ⋆ ( cos ( {λ}^{( k )} ) + \frac{sin {λ}^{( k )}}{tan ( φ - {λ}^{( k )} )} ) - {μ}_{d}^{( k )} )}^{2}} + \\ \sqrt{{\sum }_{{j}_{dwon}}^{m} {( {μ}_{L}^{( k )} {d}_{{j}_{down}} ⋆ ( \frac{sin φ}{sin ( {λ}^{( k )} + φ )} ) - {μ}_{d}^{( k )} )}^{2}}\end{matrix}}{n + m - 1} \qquad ( 10 )$$

$${ρ}^{( k )} = \frac{cov ( T , Dis )}{{σ}_{τ} {σ}_{s}^{( k )}} \qquad ( 11 )$$

in Equation (9), Equation (10) and Equation (11), and

$$φ = {90}^{∘} - \frac{γ}{2} ,$$

is a number of core speed change points in the data set of the upper road section τᵤₚ, m is a number of core speed change points in the data set of the lower road section τ_{down}, γ denotes a field of view of the camera;

Equation (12) is used to calculate an actual headway distance ωⱼ(λ^{(k)}) under the k^{th} iteration;

$${ϖ}_{j} ( {λ}^{( k )} ) = \{ \begin{matrix}{d}_{j} {L}_{i}^{( k )} / 2 ⋆ ( cos λ + \frac{sin λ}{tan ( φ − λ )} ) , {d}_{j} ∈ {d}_{up} \\ {d}_{j} ⋆ {L}_{i}^{( k )} / 2 ⋆ ( \frac{sin φ}{sin ( φ + φ )} ) , {d}_{j} ∈ {d}_{down}\end{matrix} \qquad ( 12 )$$

in Equation (12), dⱼ is a j^{th} data of the pixel number sample data set Dis;
step 7.4, Equation (13) is used to calculate an actual length value Lₛ^{(k)} of the i^{th} road pixel under the k^{th} iteration, and an actual length value range

$${L}_{sope}^{( k )} = \{ {L}_{i}^{( k )} \vert i ∈ [ \frac{min L}{step} , \frac{max L}{step} ] \}$$

of the road pixel is obtained by splicing;

$${L}_{i}^{( k )} = i ⋆ step , i ∈ [ \frac{min L}{step} , \frac{max L}{step} ] \qquad ( 13 )$$

in Equation (13), L^{(k)} denotes an i^{th} actual length estimate value of the road pixel under the k^{th} iteration, min L is a minimum value of the actual length of the road pixel, min L is 1, step denotes a step size, step is 0.00001, and max L denotes a maximum value of the actual length of the road pixel, max L is 1;
step 7.5, Equation (14) is used to obtain a probability p(L=Lᵢ^{(k)}; μ_{L}^{(k)}, σ_{L}^{(k)} of the actual length value L=Lᵢ^{(k)} of the road pixel under a μ_{L}^{(k)} and σ_{L}^{(k)} condition in the k^{th} iteration;

$$p ( L = {L}_{i}^{( k )} ; {μ}_{L}^{( k )} , {σ}_{L}^{( k )} ) = \frac{{{\int }_{{L}_{i}^{( k )}}}^{{L}_{i}^{( k )} + Δ L} Ω ( L = {L}_{i}^{( k )} ; {μ}_{L}^{( k )} , {σ}_{L}^{( k )} ) dL}{{{\int }^{1}}_{0} Ω ( L ; {μ}_{L}^{( k )} , {σ}_{L}^{( k )} ) dL} \qquad ( 14 )$$

in Equation (14), ΔL is an increment on Lᵢ^{(k)}, ΔL is 0.00001;

Equation (15) is used to calculate a probability density function Ω(L=Lᵢ^{(k)}; μ_{L}^{(k)}, σ_{L}^{(k)}) of the actual length value L=Lᵢ^{(k)} of the road pixel under the parameter μ_{L}^{(k)} and σ_{L}^{(k)} condition in the k^{th} iteration;

$$Ω ( L = {L}_{i}^{( k )} ; {μ}_{L}^{( k )} , {σ}_{L}^{( k )} ) = \frac{1}{\sqrt{2 {π ( {σ}_{L}^{( k )} )}^{∧ 2}}} {e}^{- \frac{{( {L}_{i}^{( k )} - {μ}_{L}^{( k )} )}^{∧ 2}}{2 {( {σ}_{L}^{( k )} )}^{∧ 2}}} \qquad ( 15 )$$

step 7.6, Equation (16) is used to calculate a conditional probability Qᵢⱼ^{(k)}(L=Lᵢ^{(k)}|τⱼ, dⱼ; μ_{L}^{(k)}, σ_{L}^{(k)}, λ^{(k)}, μ_{τ}^{(k)}, σ^{(k)}, λ^{(k}), μ^{(k)}, ρ^{(k)}) of L=Lᵢ^{(k)} taking the j^{th} data/in the time sample data set T and the j^{th} data dⱼ in the distance pixel sample data set Dis under the parameter μ_{L}^{(k)}, σ^{(k)}_{L}, λ^{(k)}, μ_{τ}, σ_{τ}^{, μ}ₛ^{(k)}, σₛ^{(k)}, ρ^{(k)} in the k^{th} iteration;

$$\frac{{Q}_{ij}^{( k )} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) = p ( {τ}_{j} , {d}_{j} , {L}_{i}^{( k )} ; {μ}_{L}^{( k )} , {σ}_{L}^{( k )} , {λ}^{( k )} , {μ}_{τ}^{( k )} , {σ}_{τ}^{( k )} , {μ}_{s}^{( k )} , {σ}_{s}^{( k )} , {ρ}^{( k )} )}{{\sum }_{i = 1}^{R} p ( {τ}_{j} , {d}_{j} , {L}_{i}^{( k )} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} )} \qquad ( 16 )$$

in Equation (16), p(τⱼ,dⱼ, Lᵢ^{(k)}; μ_{L}^{(k)}, σ_{L}^{(k)}, λ^{(k)}, μ_{τ}, σ_{τ}, μₛ^{(k)}, σₛ^{(k)}, ρ^{(k)} denotes a joint probability of simultaneous occurrence of τⱼ, dⱼ, Lᵢ^{(k)} under a given parameter μ_{L}^{(k)}, σ^{(k)}, λ^{(k)}, μ_{τ}, σ_{τ}, μₛ^{(k)}, σₛ^{(k)}, ρ^{(k)}, and:

$$p ( {τ}_{j} , {d}_{j} , {L}_{i}^{( k )} ; {μ}_{L}^{( k )} , {σ}_{L}^{( k )} , {λ}^{( k )} , {μ}_{r} , {σ}_{r} , {μ}_{s}^{( k )} , {σ}_{s}^{( k )} , {ρ}^{( k )} ) = p ( L = {L}_{i}^{( k )} ; {μ}_{L}^{( k )} , {σ}_{L}^{( k )} ) p ( {τ}_{j} , {d}_{j} \vert {L}_{i}^{( k )} ; {λ}^{( k )} , {μ}_{τ} , {σ}_{τ} , {μ}_{s}^{( k )} , {σ}_{s}^{( k )} , {ρ}^{( k )} ) \qquad ( 17 )$$

Equation (17) is used to calculate a conditional probability p(τⱼ,dⱼ|L=Lᵢ^{(k)};λ^{(k)}, μ_{τ}, σ_{τ}, μ^{(k)}, σₛ^{(k)}, ρ^{(k)} of τⱼ and dⱼ with the value of L=Lᵢ^{(k)} under the parameter μ_{L}^{(k)}, σ_{L}^{(k)}, λ^{(k)}, μ_{τ}, σ_{τ}, μₛ^{(k)}, σₛ^{(k)}, ρ^{(k)} in the k^{th} iteration;

$$p ( {τ}_{j} , {d}_{j} ∣ L = {L}_{i}^{( k )} ; {λ}^{( k )} , {μ}_{τ} , {σ}_{τ} , {μ}_{s}^{( k )} , {σ}_{s}^{( k )} , {ρ}^{( k )} ) = {\int }_{{τ}_{j}}^{{τ}_{j} + Δ u} {\int }_{{ϖ}_{j} ( {λ}^{( k )} )}^{{ϖ}_{j} ( {λ}^{( k )} ) + Δ v} \frac{1}{2 {πσ}_{τ}^{( k )} {σ}_{s}^{( k )} \sqrt{1 − {( {ρ}^{( k )} )}^{⋀ 2}}} {e}^{\frac{− 1}{2 ( 1 − {( {ρ}^{( k )} )}^{{⋀}_{2}} )} [ {( \frac{{τ}_{j} − {μ}_{τ}^{( k )}}{{σ}_{τ}^{( k )}} )}^{{⋀}_{2}} + {( \frac{{ϖ}_{j} ( {λ}^{( k )} − {μ}_{s}^{( k )}}{{σ}_{s}^{( k )}} )}^{2} − 2 {ρ}^{( k )} ( \frac{{τ}_{j} − {μ}_{τ}^{( k )}}{{σ}_{τ}^{( k )}} ) ( \frac{{ϖ}_{j} ( {λ}^{( k )} ) − {μ}_{s}^{( k )}}{{σ}_{s}^{( k )}} )} dudv \qquad ( 18 )$$

in Equation (18), Δu is an increment on τⱼ, Δu is 0.00001, Δv is an increment on ωⱼ(λ^{(k)}), Δv is 0.00001;
step 7.7, Equation (19) is used to update an actual length lⱼ^{(k)} of the road pixels of a j^{th} distance in the k^{th} iteration;

$${l}_{j}^{( k )} = {\sum }_{i = 1}^{R} {L}_{i} ⋆ {Q}_{ij} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) \qquad ( 19 )$$

step 7.8, Equation (20) is used to construct an objective function ∂ϑ^{(k)}(θ^{(k)}) in the k^{th} iteration;

$${Λ}^{( k )} ( {θ}^{( k )} ) = {\sum }_{j}^{J} {Q}_{j} ( L = {l}_{j}^{( k )} \vert {τ}_{j} , {d}_{j} ; {θ}^{( k )} ) log \frac{p ( {τ}_{j} , {d}_{j} , {l}_{j}^{( k )} ; {θ}^{( k )} )}{{Q}_{j} ( L = {l}_{j}^{( k )} \vert {τ}_{j} , {d}_{j} ; {θ}^{( k )} )} \qquad ( 20 )$$

step 7.9, when the objective function ∂ϑ^{(k)}(θ^{(k)}) reaches the maximum value, the least square method is used to solve the optimal estimation parameters μ_{L}*^{(k)}, σ_{L}^{*(k)}, λ^{*(k)} in the k^{th} iteration, and an optimal objective function value ϑ^{*(k)}=∂ϑ^{(k)}(θ^{*(k)});
step 7.10, judged whether k≤K and |ϑ^{*(k)}−ϑ^{(k)}|≤gap and |λ^{*(k)}−λ^{(k)}|≤gap and |μ_{L}^{*(k)}−μ_{L}^{(k)}|≤gap and |μ_{L}^{*(k)}−μ_{L}^{(k)}|≤gap are simultaneously valid, if k≤K and valid, an optimal road longitudinal slope estimation value λ^{*(k)} under the k^{th} iteration is output as a final result, if k≤K and |ϑ^{*(k)}−ϑ^{(k)}|≤gap and |λ^{*(k)}−λ^{(k)}|≤gap and |μ_{L}^{*(k)}−μ_{L}^{(k)}|≤gap and |μ_{L}^{*(k)}−μ_{L}^{(k)}|≤gap are not valid, assigned ϑ^{*(k)} to ϑ^{(k+1)}, μ_{L}^{*(k)} to μ_{L}^{(k+1)}, σ_{L}^{*(k)} to σ_{L}^{(k+1)}, λ^{*(k)} to λ^{(k+1)}, and k+1 to k, returned to step 7.3, and sequentially executed.

What is claimed is:

1. A road longitudinal slope estimation method based on an unmanned aerial vehicle aerial photography video, comprising the following steps:
step 1, placing a camera lens on a unmanned aerial vehicle perpendicular to a road horizontal plane so as to shoot a traffic flow video of a road via the unmanned aerial vehicle;
letting a total number of frames of the traffic flow video be M;
step 2, obtaining a corrected traffic flow video by correcting the traffic flow video;
step 3, determining a traffic lane J of a maximum traffic volume of a road in the corrected traffic flow video, and fitting a pixel point on a center line of the traffic lane J of a certain frame of picture in the corrected traffic flow video by using a polynomial curve to obtain a reference line;
extracting the pixel point on the reference line of each frame of picture in the corrected traffic flow video, grouping in a time dimension ϕ to obtain a traffic lane center line picture with an actual length of the road as a space dimension Z and converting the traffic lane center line picture into a grey scale image I;
step 4, extracting a trajectory contour from the grey scale image/to obtain a foreground contour of a vehicle as trajectory data, and according to an entrance and exit order of the vehicle, performing ascending order sorting on the trajectory data to obtain a trajectory data set TJ of the vehicle;
step 5, processing the trajectory data set TJ to obtain a sorted complete trajectory set TJ₂;
step 6, according to TJ₂, acquiring a core speed change point set E of all the complete trajectories by using a wavelet transform; and
step 7, assuming an actual length of a road pixel point and a value of a road longitudinal slope, obtaining a distribution of a speed change point distance and a reaction time, applying a Bayesian network and a machine learning algorithm to iteratively obtain an expected value and variance of the actual length of the road pixel point and an estimated value of the road longitudinal slope, and outputting an optimal estimated value of the road longitudinal slope.

2. The road longitudinal slope estimation method based on the unmanned aerial vehicle aerial photography video according to claim 1, wherein step 2 comprises:
step 2.1, performing a static object recognition on a first frame of picture and a last frame of picture in the traffic flow video respectively, obtaining two frame recognition results and performing a static object matching to obtain a static feature template key;
step 2.2, defining a number of current frames as r, and initializing r=1;
step 2.3, using a Fast Library for Approximate Nearest Neighbors (FLANN) algorithm to match an r^{th} frame picture in the traffic flow video with a static feature template key to obtain an r^{th} matched feature point set keyᵣ, and using Equation (1) to obtain an r^{th} perspective transformation matrix Hᵣ;
$$key = {H}_{r} \times {key}_{r} \qquad ( 1 )$$
step 2.4, correcting the r^{th} frame picture with Hᵣ to obtain a corrected r^{th} frame picture; and
step 2.5, assigning r+1 to r, and judging whether r≤M is valid, and if r≤M is valid, returning to step 2.3 for sequential execution; otherwise, it denotes the corrected traffic flow video.

3. The road longitudinal slope estimation method based on the unmanned aerial vehicle aerial photography video according to claim 2, wherein step 4 comprises:
step 4.1, acquiring a vehicle trajectory in the grey scale image I via a Canny edge detection algorithm, and after separating the vehicle trajectory from a background, obtaining a binary image A, and letting a set of pixel points with a numerical value of 1 in the binary image A constitute a foreground image B;
step 4.2, after performing corrosion and expansion operations on the foreground image B, obtaining a processed foreground image B₂, and combining the processed foreground image B₂ with the binary image A to form a new binary image A₁;
step 4.3, connecting boundary points of the vehicle trajectory in the binary image A₁ by using an eight-connection criterion to form a processed binary image A₂;
step 4.4, filtering the processed binary image A₂ by using an exponential averaging filter to obtain a noise-reduced binary image A₃;
step 4.5, separating the boundary points of the vehicle trajectory in the noise-reduced binary image A₃ according to a set time threshold value threshold₁, a vehicle length threshold value threshold₂ and a vehicle headway threshold value threshold₃, so as to obtain contour lines of different vehicles in the noise-reduced binary image A₃; and
step 4.6, analyzing the contour lines of different vehicles in the noise-reduced binary image A₃ accurately to obtain the foreground contour of the vehicle as the trajectory data, and according to the entrance and exit order of the vehicle, sorting the trajectory data in an ascending order to obtain the trajectory data set TJ of the vehicle.

4. The road longitudinal slope estimation method based on the unmanned aerial vehicle aerial photography video according to claim 3, wherein step 5 comprises:
step 5.1, calculating a distance D₁ between a starting point of the trajectory TJ_{c} of a vehicle c and a starting point of the road, and a distance D₂ between an end point of the trajectory TJ of the vehicle c and an end point of the road;
step 5.2, judging whether D₁≤threshold₄ is valid, if D₁≤threshold₄ is valid, processing to step 5.3; otherwise, adding the trajectory TJ_{c} of the vehicle c to a lower boundary disconnected trajectory TJ_{down}; wherein threshold₄ denotes a distance threshold between the starting point of the trajectory of the vehicle c and the starting point of the road;
step 5.3, judging whether D₂≤thresholds is valid, if D₂≤threshold, is valid, it indicates that the trajectory TJ_{c} of the vehicle c is a complete trajectory and storing the trajectory TJ_{c} of the vehicle c in a complete trajectory set TJ_{c}; otherwise, adding the trajectory TJ_{c} of the vehicle c to an upper boundary disconnected trajectory TJᵤₚ, wherein threshold₄ denotes a distance threshold between the end point of the trajectory of the vehicle c and the end point of the road;
step 5.4, processing the trajectories of different vehicles in the noise-reduced binary image A₃ according to the process of steps 5.1-5.3, so as to obtain a final lower boundary disconnected trajectory TJ_{down} and a final upper boundary disconnected trajectory TJᵤₚ;
step 5.5, calculating a difference D₃ between the end point of the trajectory of any lower boundary disconnected trajectory TJ_{down} and the starting point of the trajectory of any upper boundary disconnected trajectory TJᵤₚ in the time dimension ϕ, and a difference D₄ between the end point of the trajectory of the lower boundary disconnected trajectory TJ_{down} and the starting point of the trajectory of any upper boundary disconnected trajectory TJᵤₚ in the space dimension Z;
step 5.6, judging whether D₃≤threshold, and D₄≤threshold₇ are valid at the same time, if D₃≤threshold, and D₄≤threshold, are valid at the same time, then entering step 5.7;
otherwise, it indicates that the trajectory TJ_{c} of the vehicle c is a lane-changing trajectory, and is not stored in the complete trajectory set TJ′, wherein threshold, denotes a time headway threshold of the lower boundary disconnected trajectory and the upper boundary disconnected trajectory, and threshold, denotes a space threshold of the lower boundary disconnected trajectory and the upper boundary disconnected trajectory;
step 5.7, connecting a starting point P₀ of the lower boundary disconnected trajectory TJ_{down} with an end point P₁ of the upper boundary disconnected trajectory TJᵤₚ by using a first-order Bessel curve to obtain a missing trajectory TJ₁, and connecting with the upper boundary disconnected trajectory TJᵤₚ and the lower boundary disconnected trajectory TJ_{down} to form the complete trajectory TJ_{c} of the vehicle c, and storing the complete trajectory TJ_{c} of the vehicle c in the complete trajectory set TJ′; and
step 5.8. sorting the complete trajectory set TJ′ in ascending order according to an order of the trajectory, obtaining a sorted complete trajectory set TJ₂, and recording any j^{th} complete trajectory in the sorted complete trajectory set TJ₂ as trajectoryⱼ=[tⱼ, xⱼ], wherein t, is a time series of a j^{th} complete trajectory in the time dimension ϕ, and x, is a position series of the j^{th} complete trajectory in the space dimension Z.

5. The road longitudinal slope estimation method based on the unmanned aerial vehicle aerial photography video according to claim 4, wherein step 6 comprises:
step 6.1, calculating an approximate coefficient Tⱼ(a,b) of the j^{th} complete trajectory in the complete trajectory set TJ′ by Equation (2);
$${T}_{j} ( a , b ) = \frac{1}{\sqrt{a}} {\int }_{- ∞}^{∞} {trajectory}_{j} \times [ 1 - {( \frac{{t}_{j} - b}{a} )}^{2} ] {e}^{- \frac{{( \frac{{t}_{j} - b}{a} )}^{2}}{2}} d t \qquad ( 2 )$$
in Equation (2), a is a scale factor, b is a translation factor, b∈tⱼ;
step 6.2, calculating an energy distribution E; by Equation (3);
$${{E}_{j} = \frac{1}{max ( a )} {\int }_{{a}_{min}}^{{a}_{max}} \vert T ( a , b ) \vert}^{2} da \qquad ( 3 )$$
in Equation (3), aₘᵢₙ denotes a minimum value of the scale factor, aₘₐₓ denotes a maximum value of the scale factor;
step 6.3, computing
$$\frac{\partial {E}_{j}}{\partial b} = 0 ,$$
obtaining a set of speed change point time β={b₁,b₂, . . . , bᵢ, . . . , b_{R}}, wherein bᵢ denotes an i^{th} speed change point time, and R is a number of speed change points;
step 6.4, taking a corresponding speed change point under a condition meets max E_{b}|β={b₁,b₂, . . . , bᵢ} as a core speed change point, so as to obtain a time b_{η} and a position x_{η} corresponding to the core speed change point, and storing a combination [c,b_{η}, x_{η}] to the core speed change point set E; and
step 6.5, processing all the complete trajectories according to the process of steps 6.1-6.4, and obtaining the core speed change point set E.

6. The road longitudinal slope estimation method based on the unmanned aerial vehicle aerial photography video according to claim 5, wherein step 7 comprises:
step 7.1, according to the position of the core speed change point, combining core speed change points located on an upper road section into a core speed change point set of the upper road section Eᵤₚ, and combining core speed change points located on a lower road section into a core speed change point set of the lower road section E_{down};
using Equation (4) to calculate a reaction time τⱼ_{ᵤₚ} between a jᵤₚ^{th} core speed change point and a jᵤₚ+1^{th} core speed change point in the core speed change point set of the upper road section Eᵤₚ, so as to obtain a reaction time set τᵤₚ between all adjacent two core speed change points in the core speed change point set of the upper road section Eᵤₚ;
$${τ}_{{j}_{up}} = \vert {t}_{{j}_{up} + 1} - {t}_{{j}_{up}} \vert / fps , {t}_{{j}_{up}} ∈ {E}_{up} \qquad ( 4 )$$
in Equation (4), fps denotes a frame rate of a video;
using Equation (5) to calculate a distance pixel number dⱼ_{ᵤₚ} between the jᵤₚ^{th} core speed change point and the jᵤₚ+1^{th} core speed change point in the core speed change point set of the upper road section Eᵤₚ, so as to obtain a distance pixel number set dᵤₚ between all adjacent two core speed change points in the core speed change point set of the upper road section Eᵤₚ;
$${d}_{{j}_{up}} = \vert {x}_{{j}_{up} + 1} - {x}_{{j}_{up}} \vert , {x}_{{j}_{up}} ∈ {E}_{up} \qquad ( 5 )$$
using Equation (6) to calculate a reaction time τⱼ_{_{down}} between a j_{down}^{th} core speed change point and a j_{down}+1^{th} core speed change point in the core speed change point set of the lower road section E_{down}, so as to obtain a reaction time set T down between all adjacent two core speed change points in the core speed change point set of the lower road section E_{down};
$${τ}_{{j}_{down}} = \vert {t}_{{j}_{down} + 1} - {t}_{{j}_{down}} \vert / fps , {t}_{{j}_{down}} ∈ {E}_{d o w n} \qquad ( 6 )$$
using Equation (7) to calculate a distance pixel number d_{jdown} between the j_{down} core speed change point and the j_{down}+1^{th} core speed change point in the core speed change point set of the lower road section E_{down}, so as to obtain a distance pixel number set d_{down} between all adjacent two core speed change points in the core speed change point set of the lower road section E_{down}:
$${d}_{{j}_{down}} = \vert {x}_{{j}_{down} + 1} - {x}_{{j}_{down}} \vert , {x}_{{j}_{down}} ∈ {E}_{down} \qquad ( 7 )$$
combining τᵤₚ and τ_{down} into a time sample data set T, and recording a mean value of the time sample data set T as μ_{τ} and a standard deviation of the time sample data set T as σ_{τ};
combining dᵤₚ and d_{down} into a distance pixel number sample data set Dis;
step 7.2, defining a maximum number of iterations as K, an error as gap, initializing a current number of iterations k=1, the actual length L of the road pixel in a k^{th} iteration follows the mean of the actual length of the road pixel is μ_{L}^{(k)}, a standard deviation of the actual length of the road pixel in the k^{th} iteration is a normal distribution N_{L}˜(μ_{L}^{(k)}, σ_{L}^{(k)}, and an estimated value λ^{(k)} of the road longitudinal slope in the k^{th} iteration, and an objective function value in the k^{th} iteration is ∂^{(k)};
step 7.3, using Equation (8), Equation (9) and Equation (10) to respectively obtain a mean value μₛ^{(k)} of an actual headway distance in the k^{th} iteration, a standard deviation σₛ^{(k)} of an actual headway distance in the k^{th} iteration and a covariance ρ^{(k)} in the k^{th} iteration, so as to obtain relevant parameters (μₛ^{(k)}, σₛ^{(k)}, ρ^{(k)} of the reaction time T between the core speed change points and the actual headway distance S obeying a bivariate normal distribution N_{(r,s)} in the k^{th} iteration;
$${μ}_{s}^{( k )} = \frac{\begin{matrix}{\sum }_{{j}_{up} = 1}^{n} {μ}_{L}^{( k )} * {d}_{{j}_{up}}^{( k )} * ( cos ( {λ}^{( k )} ) + \frac{sin {λ}^{( k )}}{tan ( φ - {λ}^{( k )} )} ) + \\ {\sum }_{{j}_{down} = 1}^{m} {μ}_{L}^{( k )} * {d}_{{j}_{down}}^{( k )} * ( \frac{sin φ}{sin ( {λ}^{( k )} + φ )} )\end{matrix}}{n + m - 1} \qquad ( 8 )$$
$${σ}_{s}^{( k )} = \frac{\begin{matrix}\sqrt{{\sum }_{{j}_{up} = 1}^{n} {( {μ}_{L}^{( k )} * {d}_{{j}_{up}}^{( k )} * ( cos ( {λ}^{( k )} ) + \frac{sin {λ}^{( k )}}{tan ( φ - {λ}^{( k )} )} ) - {μ}_{d}^{( k )} )}^{2}} + \\ \sqrt{{\sum }_{{j}_{down} = 1}^{m} {( {μ}_{L}^{( k )} {d}_{{j}_{down}} * ( \frac{sin φ}{sin ( {λ}^{( k )} + φ )} ) - {μ}_{d}^{( k )} )}^{2}}\end{matrix}}{n + m - 1} \qquad ( 9 )$$
$${ρ}^{( k )} = \frac{cov ( T , Dis )}{{σ}_{τ} {σ}_{s}^{( k )}} \qquad ( 10 )$$
in Equation (8), Equation (9) and Equation (10), and
$$φ = 90 ° - \frac{γ}{2} ,$$
n is a number of core speed change points in a data set of the upper road section τᵤₚ, m is a number of core speed change points in a data set of the lower road section τ_{down}, and γ denotes a field of view of a camera;
calculating an actual headway distance ωⱼ(λ^{(k)}) under the k^{th} iteration by using Equation (11);
$${ϖ}_{j} ( {λ}^{( k )} ) = \{ \begin{matrix}{d}_{j} ⋆ {L}_{i}^{( k )} / 2 ⋆ ( cos λ + \frac{sin λ}{tan ( φ − λ )} ) , {d}_{j} ∈ {d}_{up} \\ {d}_{j} ⋆ {L}_{i}^{( k )} / 2 ⋆ ( \frac{sin φ}{sin ( φ + φ )} ) , {d}_{j} ∈ {d}_{down}\end{matrix} \qquad ( 11 )$$
in Equation (11), dⱼ is j^{th} data of the distance pixel number sample data set Dis;
step 7.4, calculating an actual length value Lk of the i^{th} road pixel under the k^{th} iteration by using Equation (12), and obtaining an actual length value range
$${L}_{sope}^{( k )} = \{ {L}_{i}^{( k )} \vert i ∈ [ \frac{min L}{step} , \frac{max L}{step} ] \}$$
of the road pixel by splicing;
$${L}_{i}^{( k )} = i ⋆ step , i ∈ [ \frac{min L}{step} , \frac{max L}{step} ] \qquad ( 12 )$$
in Equation (11), Lk denotes an i^{th} actual length estimate value of the road pixel under the k^{th} iteration, min L is a minimum value of the actual length of the road pixel, step denotes a step size, and max L denotes a maximum value of the actual length of the road pixel;
step 7.5, obtaining a probability p(L=Lₛ^{(k)}; μ_{L}^{(k)}, σ_{L}^{(k)}) of the actual length value L=L^{(k)} of the road pixel under a μ_{L}^{(k)} and σ_{L}^{(k)} condition in the k^{th} iteration by using Equation (13);
$$p ( L = {L}_{i}^{( k )} ; {μ}_{L}^{( k )} , {σ}_{L}^{( k )} ) = \frac{{\int }_{{L}_{i}^{( k )}}^{{ζ}^{( k )} + Δ L} Ω ( L = {L}_{i}^{( k )} ; {μ}_{L}^{( k )} , {σ}_{L}^{( k )} ) dL}{{\int }_{0}^{1} Ω ( L ; {μ}_{L}^{( k )} , {σ}_{L}^{( k )} ) dL} \qquad ( 13 )$$
in Equation (13), ΔL is an increment on L^{(k)};
calculating a probability density function Ω(L=L^{(k)}; μ^{k}) or of the actual length value L=L^{(k)} of the road pixel under parameter μ_{L}^{(k)} and σ_{L}^{(k)} condition in the k^{th} iteration by using Equation (14);
$$Ω ( L = {L}_{i}^{( k )} ; {μ}_{L}^{( k )} , {σ}_{L}^{( k )} ) = \frac{1}{\sqrt{2 {π ( {σ}_{L}^{( k )} )}^{∧ 2}}} {e}^{\frac{- {( {L}_{i}^{( k )} - {μ}_{L}^{( k )} )}^{∧ 2}}{2 {( {σ}_{L}^{( k )} )}^{∧ 2}}} \qquad ( 14 )$$
step 7.6, using Equation (15) to calculate a conditional probability Qᵢⱼ^{(k)}(L=Lᵢ^{(k)}|τⱼ,dⱼμ_{L}^{(k)}, σ_{L}^{(k)}, λ^{(k)}, σ_{τ}^{(k)}, λ^{(k)}, μ_{τ}^{(k)}, σₛ^{(k)}, ρ^{(k)} of L=Lᵢ^{(k)} taking the j^{th} data τⱼ in the time sample data set T and the j^{th} data dⱼ in the distance pixel number sample data set Dis under parameter μ_{L}^{(k)}, σ_{L}^{(k)}, λ^{(k)}, μ_{τ}, σ^{τ}, μₛ^{(k)}, σₛ^{(k)}, σₛ^{(k)}, ρ^{(k)} in the k^{th} iteration;
$${Q}_{ij}^{( k )} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) = \frac{p ( {τ}_{j} , {d}_{j} , {L}_{i}^{( k )} ; {μ}_{L}^{( k )} , {σ}_{L}^{( k )} , {λ}^{( k )} , {μ}_{τ}^{( k )} , {σ}_{τ}^{( k )} , {μ}_{s}^{( k )} , {σ}_{s}^{( k )} , {ρ}^{( k )} )}{{{\sum }^{R}}_{i = 1} p ( {τ}_{j} , {d}_{j} , {L}_{i}^{( k )} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} )} \qquad ( 15 )$$
in Equation (15), p(τ)ⱼ,dⱼ, Lᵢ^{(k)}; μ_{L}^{(k)}, σ_{L}^{(k)}, λ^{(k)}, μ_{τ}, σ_{τ}, μₛ^{(k)}, σₛ^{(k)}, ρ^{(k)} denotes a joint probability of simultaneous occurrence of τⱼ, dⱼ, Lᵢ^{(k)} under a given parameter μ_{L}^{(k)}, σ_{L}^{(k)}, λ^{(k)}, σ_{τ}, μₛ^{(k)}, σₛ^{(k)}, ρ^{(k)}, and:
$$p ( {τ}_{j} , {d}_{j} , {L}_{i}^{( k )} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) = p ( L = {L}_{i}^{( k )} ; {μ}_{L}^{( k )} , {σ}_{L}^{( k )} ) p ( {τ}_{j} , {d}_{j} \vert {L}_{i}^{( k )} ; {λ}^{( k )} , {μ}_{τ} , {σ}_{τ} , {μ}_{s}^{( k )} , {σ}_{s}^{( k )} , {ρ}^{( k )} ) \qquad ( 16 )$$
calculating a conditional probability p(τⱼ,dⱼ|L=Lᵢ^{(k)}; λ^{(k)}, μ^{(k)}, σ_{τ}, μₛ^{(k)}, σₛ^{(k)}, ρ^{(k)} of τⱼ and dⱼ with the value of L=Lᵢ^{(k)} under the parameter μ_{L}^{(k)}, σ_{L}^{(k)}, λ^{(k)}, μ_{τ}, σ_{τ}, μₛ^{(k)}, σ^{(k)}, ρ^{(k)} in the k^{th} iteration by using Equation (17);
$$p ( {τ}_{j} , {d}_{j} \vert L = {L}_{i}^{( k )} ; {λ}^{( k )} , {μ}_{τ} , {σ}_{τ} , {μ}_{s}^{( k )} , {σ}_{s}^{( k )} , {ρ}^{( k )} ) = {\int }_{{τ}_{j}}^{{τ}_{j} + Δ u} {\int }_{{\overline{ω}}_{j} ( {λ}^{( k )} )}^{{\overline{ω}}_{j} ( {λ}^{( k )} ) + Δ v} \frac{1}{2 π {σ}_{τ}^{( k )} {σ}_{s}^{( k )} \sqrt{1 - {( {ρ}^{( k )} )}^{\hat{} 2}}} {e}^{\frac{- 1}{2 ( 1 - {( {ρ}^{( k )} )}^{\hat{} 2} )} [ {( \frac{{τ}_{j} - {μ}_{τ}^{( k )}}{{σ}_{τ}^{( k )}} )}^{\hat{} 2} + {( \frac{{\overline{ω}}_{j} ( {λ}^{( k )} ) - {μ}_{s}^{( k )}}{{σ}_{s}^{( k )}} )}^{2} - 2 {ρ}^{( k )} ( \frac{{τ}_{j} - {μ}_{τ}^{( k )}}{{σ}_{τ}^{( k )}} ) ( \frac{{\overline{ω}}_{j} ( {λ}^{( k )} ) - {μ}_{s}^{( k )}}{{σ}_{s}^{( k )}} ) ]} dudv \qquad ( 17 )$$
in Equation (17), Δu is an increment on τⱼ, and Δv is an increment on ωⱼ(λ^{(k)});
step 7.7, updating an actual length lⱼ^{(k)} of the road pixels of a j^{th} distance in the k^{th} iteration by using Equation (18);
$${l}_{j}^{( k )} = {\sum }_{i = 1}^{R} {L}_{j} * {Q}_{ij} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) \qquad ( 18 )$$
step 7.8, constructing an objective function Λ^{(k)}(θ^{(k)}) in the k^{th} iteration by using Equation (19);
$${Λ}^{( k )} ( {θ}^{( k )} ) = {\sum }_{j}^{J} {Q}_{j} ( L = {l}_{j}^{( k )} \vert {τ}_{j} , {d}_{j} ; {θ}^{( k )} ) log \frac{p ( {τ}_{j} , {d}_{j} , {l}_{j}^{( k )} ; {θ}^{( k )} )}{{Q}_{j} ( L = {l}_{j}^{( k )} \vert {τ}_{j} , {d}_{j} ; {θ}^{( k )} )} \qquad ( 19 )$$
step 7.9, when the objective function Λ^{(k)}(θ^{(k)}) reaches a maximum value, using a least square method to solve an actual length mean value μ_{L}^{*(k)} of an optimal road pixel, an actual length standard deviation σ_{L}^{*(k)} of the optimal road pixel, and an estimated value λ^{*(k)} of an optimal road longitudinal slope in the k^{th} iteration, and an optimal objective function value ϑ^{*(k)}=Λ^{(k)}(θ^{*(k)}); and
step 7.10, judging whether k≤K and |ϑ^{*(k)}−ϑ^{(k)}≤gap and |λ^{*(k)}−λ^{(k)}|≤gap and |μ_{L}^{*(k)}−μ_{L}^{(k)}|≤gap and |μ_{L}^{*(k)}−μ_{L}^{(k)}| gap are simultaneously valid, if k≤K and |ϑ^{*(k)}−ϑ^{(k)}|≤gap and |λ^{*(k)}−λ_{L}^{(k)}|≤gap and |μ^{*(k)}−μ_{L}^{(k)}|≤gap and |μ_{L}^{*(k)}−μ_{L}^{(k)}|≤gap are valid, outputting an optimal road longitudinal slope estimation value λ^{*(k)} under the k^{th} iteration as a final result, if k≤K and |ϑ^{*(k)}−ϑ^{(k)}|≤gap and |λ^{*(k)}−λ^{(k)}|≤gap and |μ_{L}^{*(k)}−μ_{L}^{(k)}|≤gap and |μ_{L}^{*(k)}−μ_{L}^{(k)}|≤gap are not valid, assigning ϑ^{*(k)} to ϑ^{(k+1)}, μ_{L}^{*(k)} to μ_{L}^{(k+1)}, σ_{L}^{*(k)} to σ_{L}^{(k+1)}, λ^{*(k)} to λ^{(k+1)}, and k+1 to k, returning to step 7.3, and sequentially executing.

7. An electronic device, comprising a memory and a processor, wherein the memory is used to store a program, wherein the program supports the processor to perform the road longitudinal slope estimation method based on the unmanned aerial vehicle aerial photography video according to claim 1, and the processor is configured to perform the program stored in the memory.

8. A computer-readable storage medium, wherein a computer program is stored on the computer-readable storage medium, and the computer program runs the road longitudinal slope estimation method based on the unmanned aerial vehicle aerial photography video according to claim 1 when the computer program is executed by a processor.

9. The electronic device according to claim 7, wherein step 2 in the road longitudinal slope estimation method based on the unmanned aerial vehicle aerial photography video comprises:
step 2.1, performing a static object recognition on a first frame of picture and a last frame of picture in the traffic flow video respectively, obtaining two frame recognition results and performing a static object matching to obtain a static feature template key;
step 2.2, defining a number of current frames as r, and initializing r=1;
step 2.3, using a FLANN algorithm to match an r^{th} frame picture in the traffic flow video with a static feature template key to obtain an r^{th} matched feature point set keyᵣ, and using Equation (1) to obtain an r^{th} h perspective transformation matrix Hᵣ;
$$key = {H}_{r} \times {key}_{r} \qquad ( 1 )$$
step 2.4, correcting the r^{th} frame picture with Hᵣ to obtain a corrected r^{th} frame picture; and
step 2.5, assigning r+1 to r, and judging whether r≤M is valid, and if r≤M is valid, returning to step 2.3 for sequential execution; otherwise, it denotes the corrected traffic flow video.

10. The electronic device according to claim 9, wherein step 4 in the road longitudinal slope estimation method based on the unmanned aerial vehicle aerial photography video comprises:
step 4.1, acquiring a vehicle trajectory in the grey scale image I via a Canny edge detection algorithm, and after separating the vehicle trajectory from a background, obtaining a binary image A, and letting a set of pixel points with a numerical value of 1 in the binary image A constitute a foreground image B;
step 4.2, after performing corrosion and expansion operations on the foreground image B, obtaining a processed foreground image B₂, and combining the processed foreground image B₂ with the binary image A to form a new binary image A₁;
step 4.3, connecting boundary points of the vehicle trajectory in the binary image A₁ by using an eight-connection criterion to form a processed binary image A₂;
step 4.4, filtering the processed binary image A₂ by using an exponential averaging filter to obtain a noise-reduced binary image A₃;
step 4.5, separating the boundary points of the vehicle trajectory in the noise-reduced binary image A₃ according to a set time threshold value threshold₁, a vehicle length threshold value threshold, and a vehicle headway threshold value threshold₃, so as to obtain contour lines of different vehicles in the noise-reduced binary image A₃; and
step 4.6, analyzing the contour lines of different vehicles in the noise-reduced binary image A₃ accurately to obtain the foreground contour of the vehicle as the trajectory data, and according to the entrance and exit order of the vehicle, sorting the trajectory data in an ascending order to obtain the trajectory data set TJ of the vehicle.

11. The electronic device according to claim 10, wherein step 5 in the road longitudinal slope estimation method based on the unmanned aerial vehicle aerial photography video comprises:
step 5.1, calculating a distance D₁ between a starting point of the trajectory TJ_{c} of a vehicle c and a starting point of the road, and a distance D₂ between an end point of the trajectory TJ_{c} of the vehicle c and an end point of the road;
step 5.2, judging whether D₁≤threshold, is valid, if D₁≤threshold₄ is valid, processing to step 5.3; otherwise, adding the trajectory TJ_{c} of the vehicle c to a lower boundary disconnected trajectory TJ_{down}; wherein threshold, denotes a distance threshold between the starting point of the trajectory of the vehicle c and the starting point of the road;
step 5.3, judging whether D₂≤thresholds is valid, if D₂≤thresholds is valid, it indicates that the trajectory TJ_{c} of the vehicle c is a complete trajectory and storing the trajectory TJ_{c} of the vehicle c in a complete trajectory set TJ′; otherwise, adding the trajectory TJ_{c} of the vehicle c to an upper boundary disconnected trajectory TJ, wherein threshold₄ denotes a distance threshold between the end point of the trajectory of the vehicle c and the end point of the road;
step 5.4, processing the trajectories of different vehicles in the noise-reduced binary image A₃ according to the process of steps 5.1-5.3, so as to obtain a final lower boundary disconnected trajectory TJ_{down} and a final upper boundary disconnected trajectory TJ up;
step 5.5, calculating a difference D₃ between the end point of the trajectory of any lower boundary disconnected trajectory TJ_{down} and the starting point of the trajectory of any upper boundary disconnected trajectory TJ, in the time dimension @, and a difference D₄ between the end point of the trajectory of the lower boundary disconnected trajectory TJ_{down} and the starting point of the trajectory of any upper boundary disconnected trajectory TJ″, in the space dimension Z;
step 5.6, judging whether D₃≤threshold, and D₄≤threshold, are valid at the same time, if D₃≤threshold, and D₄≤threshold, are valid at the same time, then entering step 5.7; otherwise, it indicates that the trajectory TJ_{c} of the vehicle c is a lane-changing trajectory, and is not stored in the complete trajectory set TJ′, wherein threshold, denotes a time headway threshold of the lower boundary disconnected trajectory and the upper boundary disconnected trajectory, and threshold, denotes a space threshold of the lower boundary disconnected trajectory and the upper boundary disconnected trajectory;
step 5.7, connecting a starting point P₀ of the lower boundary disconnected trajectory TJ_{down} with an end point P of the upper boundary disconnected trajectory TJᵤₚ by using a first-order Bessel curve to obtain a missing trajectory TJ₁, and connecting with the upper boundary disconnected trajectory TJᵤₚ and the lower boundary disconnected trajectory TJ_{down} to form the complete trajectory TJ_{c} of the vehicle c, and storing the complete trajectory TJ_{c} of the vehicle c in the complete trajectory set TJ′; and
step 5.8. sorting the complete trajectory set TJ′ in ascending order according to an order of the trajectory, obtaining a sorted complete trajectory set TJ₂, and recording any j^{th} complete trajectory in the sorted complete trajectory set TJ₂ as trajectoryⱼ=[tⱼ,xⱼ], wherein t, is a time series of a j^{th} complete trajectory in the time dimension ϕ, and x_{c} is a position series of the j^{th} complete trajectory in the space dimension Z.

12. The electronic device according to claim 11, wherein step 6 in the road longitudinal slope estimation method based on the unmanned aerial vehicle aerial photography video comprises:
step 6.1, calculating an approximate coefficient Tⱼ(a,b) of the j^{th} complete trajectory in the complete trajectory set TJ′ by Equation (2);
$${T}_{j} ( a , b ) = \frac{1}{\sqrt{a}} {\int }_{- ∞}^{∞} {trajectory}_{j} \times [ 1 - {( \frac{{t}_{j} - b}{a} )}^{2} ] {e}^{- \frac{{( \frac{{t}_{j} - b}{a} )}^{2}}{2}} dt \qquad ( 2 )$$
in Equation (2), a is a scale factor, b is a translation factor, b∈tⱼ;
step 6.2, calculating an energy distribution Eⱼ by Equation (3);
$${E}_{j} = \frac{1}{max ( a )} {\int }_{{a}_{min}}^{{a}_{max}} {\vert T ( a , b ) \vert}^{2} da \qquad ( 3 )$$
in Equation (3), aₘᵢₙ denotes a minimum value of the scale factor, aₘₐₓ denotes a maximum value of the scale factor;
$$\frac{\partial {E}_{j}}{\partial b} = 0 ,$$
step 6.3, computing obtaining a set of speed change point time β={b₁, b₂, . . . , bᵢ, . . . , b_{R}}, wherein bᵢ denotes an i^{th} speed change point time, and R is a number of speed change points;
step 6.4, taking a corresponding speed change point under a condition meets max E_{b}|β={b₁, b₂, . . . , bᵢ} as a core speed change point, so as to obtain a time by and a position x_{η} corresponding to the core speed change point, and storing a combination [c,b_{η}, x_{η}] to the core speed change point set E; and
step 6.5, processing all the complete trajectories according to the process of steps 6.1-6.4, and obtaining the core speed change point set E.

13. The electronic device according to claim 12, wherein step 7 in the road longitudinal slope estimation method based on the unmanned aerial vehicle aerial photography video comprises:
step 7.1, according to the position of the core speed change point, combining core speed change points located on an upper road section into a core speed change point set of the upper road section Eᵤₚ, and combining core speed change points located on a lower road section into a core speed change point set of the lower road section E_{down};
using Equation (4) to calculate a reaction time σ, between a jᵤₚ core speed change point and a jᵤₚ+1^{th} core speed change point in the core speed change point set of the upper road section Eᵤₚ, so as to obtain a reaction time set τᵤₚ between all adjacent two core spee change points in the core speed change point set of the upper road section Eᵤₚ;
$${τ}_{{j}_{up}} = \vert {t}_{{j}_{up} + 1} - {t}_{{j}_{up}} \vert / fps , {t}_{{j}_{up}} ∈ {E}_{up} \qquad ( 4 )$$
in Equation (4), fps denotes a frame rate of a video;
using Equation (5) to calculate a distance pixel number dⱼ_{ᵤₚ} between the jᵤₚ^{th} core speed change point and the jᵤₚ+1^{th} core speed change point in the core speed change point set of the upper road section Eᵤₚ, so as to obtain a distance pixel number set dᵤₚ between all adjacent two core speed change points in the core speed change point set of the upper road section Eᵤₚ;
$${d}_{{j}_{up}} = \vert {x}_{{j}_{up} + 1} - {x}_{{j}_{up}} \vert , {x}_{{j}_{up}} ∈ {E}_{up} \qquad ( 5 )$$
using Equation (6) to calculate a reaction time τⱼ_{_{down}} between a j_{down} core speed change point and a j_{down}+1^{th} core speed change point in the core speed change point set of the lower road section E_{down}, so as to obtain a reaction time set T down between all adjacent two core speed change points in the core speed change point set of the lower road section E down:
$${τ}_{{j}_{down}} = \vert {t}_{{j}_{down} + 1} - {t}_{{j}_{down}} \vert / fps , {t}_{{j}_{down}} ∈ {E}_{down} \qquad ( 6 )$$
using Equation (7) to calculate a distance pixel number dⱼ_{_{down}} between the j_{down} core speed change point and the j_{down}+1^{th} core speed change point in the core speed change point set of the lower road section E_{down}, so as to obtain a distance pixel number set d_{down} between all adjacent two core speed change points in the core speed change point set of the lower road section E_{down};
$${d}_{{j}_{down}} = \vert {x}_{{j}_{down} + 1} - {x}_{{j}_{down}} \vert , {x}_{{j}_{down}} ∈ {E}_{down} \qquad ( 7 )$$
combining τᵤₚ and τ_{down} into a time sample data set T, and recording a mean value of the time sample data set T as μ_{τ}, and a standard deviation of the time sample data set T as σ;
combining dᵤₚ and d_{down} into a distance pixel number sample data set Dis;
step 7.2, defining a maximum number of iterations as K, an error as gap, initializing a current number of iterations k=1, the actual length L of the road pixel in a k^{th} iteration follows the mean of the actual length of the road pixel is μ_{L}^{(k)}, a standard deviation of the actual length of the road pixel in the k^{th} iteration is a normal distribution N_{L}˜(μ_{L}^{(k)}, σ_{L}^{(k)}) of σ_{L}^{(k)}, and an estimated value λ^{(k)} of the road longitudinal slope in the k^{th} iteration, and an objective function value in the k^{th} iteration is ϑ^{(k)};
step 7.3, using Equation (8), Equation (9) and Equation (10) to respectively obtain a mean value μₛ^{(k)} of an actual headway distance in the k^{th} iteration, a standard deviation σₛ^{(k)} of an actual headway distance in the k^{th} iteration and a covariance ρ^{(k)} in the k^{th} iteration, so as to obtain relevant parameters (μₛ^{(k)}, σₛ^{(k)}, ρ^{(k)}) of the reaction time τ between the core speed change points and the actual headway distance S obeying a bivariate normal distribution N_{(τ,s)} in the k^{th} iteration;
$${μ}_{s}^{( k )} = \frac{\begin{matrix}{\sum }_{{j}_{up} = 1}^{n} {μ}_{L}^{( k )} * {d}_{{j}_{up}}^{( k )} * ( cos ( {λ}^{( k )} ) + \frac{sin {λ}^{( k )}}{tan ( φ - {λ}^{( k )} )} ) + \\ {\sum }_{{j}_{down} = 1}^{m} {μ}_{L}^{( k )} * {d}_{{j}_{down}}^{( k )} * ( \frac{sin φ}{sin ( {λ}^{( k )} + φ )} )\end{matrix}}{n + m - 1} \qquad ( 8 )$$
$${σ}_{s}^{( k )} = \frac{\begin{matrix}\sqrt{{\sum }_{{j}_{up} = 1}^{n} {( {μ}_{L}^{( k )} {d}_{{j}_{up}} * ( cos ( {λ}^{( k )} ) + \frac{sin {λ}^{( k )}}{tan ( φ - {λ}^{( k )} )} ) - {μ}_{d}^{( k )} )}^{2}} + \\ \sqrt{{\sum }_{{j}_{down} = 1}^{m} {( {μ}_{L}^{( k )} {d}_{{j}_{down}} * ( \frac{sin φ}{sin ( {λ}^{( k )} + φ )} ) - {μ}_{d}^{( k )} )}^{2}}\end{matrix}}{n + m - 1} \qquad ( 9 )$$
$${ρ}^{( k )} = \frac{cov ( T , Dis )}{{σ}_{τ} {σ}_{s}^{( k )}} \qquad ( 10 )$$
in Equation (8), Equation (9) and Equation (10), and
$$φ = 90 ° - \frac{γ}{2} ,$$
n is a number of core speed change points in a data set of the upper road section τᵤₚ, m is a number of core speed change points in a data set of the lower road section τ_{down}, and γ denotes a field of view of a camera;
calculating an actual headway distance ωⱼ(μ^{(k)}) under the k^{th} iteration by using Equation (11);
$${\overline{ω}}_{j} ( {λ}^{( k )} ) = \{ \begin{matrix}{d}_{j} * {L}_{i}^{( k )} / 2 * ( cos λ + \frac{sin λ}{tan ( φ - λ )} , {d}_{j} ∈ {d}_{up} \\ {d}_{j} * {L}_{i}^{( k )} / 2 * ( \frac{sin φ}{sin ( φ + φ )} ) , {d}_{j} ∈ {d}_{down}\end{matrix} \qquad ( 11 )$$
in Equation (11), dⱼ is j^{th} data of the distance pixel number sample data set Dis;
step 7.4, calculating an actual length value Lᵢ^{(k)} of the i^{th} road pixel under the k^{th} iteration by using Equation (12), and obtaining an actual length value range
$${L}_{sope}^{( k )} = \{ {L}_{i}^{( k )} \vert i ∈ [ \frac{min L}{step} , \frac{max L}{step} ] \}$$
of the road pixel by splicing;
$${L}_{i}^{( k )} = i * step , i ∈ [ \frac{min L}{step} , \frac{max L}{step} ] \qquad ( 12 )$$
in Equation (11), Lᵢ^{(k)} denotes an i^{th} actual length estimate value of the road pixel under the k^{th} iteration, min L is a minimum value of the actual length of the road pixel, step denotes a step size, and max L denotes a maximum value of the actual length of the road pixel;
step 7.5, obtaining a probability p(L=Lᵢ^{(k)}; μ_{L}^{(k)}, σ_{L}^{(k)}) of the actual length value L=Lᵢ^{(k)} of the road pixel under a μ_{L}^{(k)} and σ_{L}^{(k)} condition in the k^{th} iteration by using Equation (13);
$$p ( L = {L}_{i}^{( k )} ; {μ}_{L}^{( k )} , {σ}_{L}^{( k )} ) = \frac{{\int }_{{L}_{i}^{( k )}}^{{L}_{i}^{( k )} + Δ L} Ω ( L = {L}_{i}^{( k )} ; {μ}_{L}^{( k )} , {σ}_{L}^{( k )} ) dL}{{\int }_{0}^{1} Ω ( L ; {μ}_{L}^{( k )} , {σ}_{L}^{( k )} ) dL} \qquad ( 13 )$$
in Equation (13), ΔL is an increment on Lᵢ^{(k)};
calculating a probability density function Ω(L=Lᵢ^{(k)}; μ_{L}^{(k)}, σ^{(k)}) of the actual length value L=Lᵢ^{(k)} of the road pixel under parameter μ_{L}^{(k)} and σ_{L}^{(k)} condition in the k^{th} iteration by using Equation (14);
$$Ω ( L = {L}_{i}^{( k )} ; {μ}_{L}^{( k )} , {σ}_{L}^{( k )} ) = \frac{1}{\sqrt{2 {π ( {σ}_{L}^{( k )} )}^{\hat{} 2}}} {e}^{\frac{- {( {L}_{i}^{( k )} - {μ}_{L}^{( k )} )}^{\hat{} 2}}{2 {( {σ}_{L}^{( k )} )}^{\hat{} 2}}} \qquad ( 14 )$$
step 7.6, using Equation (15) to calculate a conditional probability Qᵢⱼ^{(k)}(L=Lᵢ^{(k)}|τⱼ, dⱼ; μ_{L}^{(k)}, σ_{L}^{(k)}, λ^{(k)}, μ_{τ}^{(k)}, σ_{τ}^{(k)}, μₛ^{(k)}, σₛ^{(k)}, ρ^{(k)}) of L=Lᵢ^{(k)} taking the j^{th} data τⱼ in the time sample data set T and the j^{th} data dⱼ in the distance pixel number sample data set Dis under parameter μ_{L}^{(k)}, σ_{L}^{(k)}, λ^{(k)}, μ_{τ}, σₛ^{(k)}, ρ^{(k)}, in the k^{th} iteration;
$${Q}_{ij}^{( k )} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) = \frac{p ( {τ}_{j} , {d}_{j} , {L}_{i}^{( k )} ; {μ}_{L}^{( k )} , {σ}_{L}^{( k )} , {λ}^{( k )} , {μ}_{τ}^{( k )} , {σ}_{τ}^{( k )} , {μ}_{s}^{( k )} , {σ}_{s}^{( k )} , {ρ}^{( k )} )}{{{\sum }^{R}}_{i = 1} p ( {τ}_{j} , {d}_{j} , {L}_{i}^{( k )} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} )} \qquad ( 15 )$$
in Equation (15), p(τⱼ,dⱼ,Lᵢ^{(k)}; μ_{L}^{(k)}, σₛ^{(k)}, λ^{(k)}, μ_{τ}, σₛ^{(k)}, μₛ^{(k)}, σₛ^{(k)}, ρ^{(k)} denotes a joint probability of simultaneous occurrence of τⱼ,dⱼ, Lᵢ^{(k)} under a given parameter μ_{L}^{(k)}, σ_{L}^{(k)}, λ^{(k)}, μ_{τ}, σₛ^{(k)}, μₛ^{(k)}, σₛ^{(k)}, ρ^{(k)}, and:
$$p ( {τ}_{j} , {d}_{j} , {L}_{i}^{( k )} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) = p ( L = {L}_{i}^{( k )} ; {μ}_{L}^{( k )} , {σ}_{L}^{( k )} ) p ( {τ}_{j} , {d}_{j} \vert {L}_{i}^{( k )} ; {λ}^{( k )} , {μ}_{τ} , {σ}_{τ} , {μ}_{s}^{( k )} , {σ}_{s}^{( k )} , {ρ}^{( k )} ) \qquad ( 16 )$$
calculating a conditional probability p(τⱼ,dⱼ|L=Lᵢ^{(k)};λ^{(k)}, μ_{τ}, σ_{τ}, μₛ^{(k)}, σₛ^{(k)}, ρ^{(k)}) of τⱼ and dⱼ with the value of L=Lᵢ^{(k)} under the parameter μ_{L}^{(k)}, σ_{L}^{(k)}, λ^{(k)}, μ_{τ}, σ_{τ}, μₛ^{(k)}, σₛ^{(k)}, ρ^{(k)} in the k^{th} iteration by using Equation (17);
$$p ( {τ}_{j} , {d}_{j} \vert L = {L}_{i}^{( k )} ; {λ}^{( k )} , {μ}_{τ} , {σ}_{τ} , {μ}_{s}^{( k )} , {σ}_{s}^{( k )} , {ρ}^{( k )} ) = {\int }_{{τ}_{j}}^{{τ}_{j} + Δ u} {\int }_{{\overline{ω}}_{j} ( {λ}^{( k )} )}^{{\overline{ω}}_{j} ( {λ}^{( k )} ) + Δ v} \frac{1}{2 π {σ}_{τ}^{( k )} {σ}_{s}^{( k )} \sqrt{1 - {( {ρ}^{( k )} )}^{\hat{} 2}}} {e}^{\frac{- 1}{2 ( 1 - {( {ρ}^{( k )} )}^{\hat{} 2} )} [ {( \frac{{τ}_{j} - {μ}_{τ}^{( k )}}{{σ}_{τ}^{( k )}} )}^{\hat{} 2} + {( \frac{{\overline{ω}}_{j} ( {λ}^{( k )} ) - {μ}_{s}^{( k )}}{{σ}_{s}^{( k )}} )}^{2} - 2 {ρ}^{( k )} ( \frac{{τ}_{j} - {μ}_{τ}^{( k )}}{{σ}_{τ}^{( k )}} ) ( \frac{{\overline{ω}}_{j} ( {λ}^{( k )} ) - {μ}_{s}^{( k )}}{{σ}_{s}^{( k )}} ) ]} dudv \qquad ( 17 )$$
in Equation (17), Δu is an increment on τⱼ, and Δv is an increment on ωⱼ(λ^{(k)});
step 7.7, updating an actual length lⱼ^{(k)} of the road pixels of a j^{th} distance in the k^{th} iteration by using Equation (18);
$${l}_{j}^{( k )} = {\sum }_{i = 1}^{R} {L}_{i} * {Q}_{ij} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) \qquad ( 18 )$$
step 7.8, constructing an objective function Λ^{(k)}(θ^{(k)}) in the k^{th} iteration by using Equation (19);
$${Λ}^{( k )} ( {θ}^{( k )} ) = {\sum }_{j}^{J} {Q}_{j} ( L = {l}_{j}^{( k )} \vert {τ}_{j} , {d}_{j} ; {θ}^{( k )} ) log \frac{p ( {τ}_{j} , {d}_{j} , {l}_{j}^{( k )} ; {θ}^{( k )} )}{{Q}_{j} ( L = {l}_{j}^{( k )} \vert {τ}_{j} , {d}_{j} ; {θ}^{( k )} )} \qquad ( 19 )$$
step 7.9, when the objective function Λ^{(k)}(θ^{(k)}) reaches a maximum value, using a least square method to solve an actual length mean value μ_{L}^{*(k)} of an optimal road pixel, an actual length standard deviation σ_{L}^{*(k)} of the optimal road pixel, and an estimated value λ^{*(k)} of an optimal road longitudinal slope in the k^{th} iteration, and an optimal objective function value ϑ^{*(k)}=Λ^{(k)}(θ^{*(k)}); and
step 7.10, judging whether k≤K and |ϑ^{*(k)}−ϑ^{(k)}≤gap and |λ^{*(k)}−λ^{(k)}|≤gap and |μ_{L}^{*(k)}−μ_{L}^{(k)})|≤gap and |μ_{L}^{*(k)}−μ_{L}^{(k)}|≤gap are simultaneously valid, if k≤K and |ϑ^{*(k)}−ϑ^{(k)}|≤gap and |λ^{*(k)}−λ^{(k)}|≤gap and |μ_{L}^{*(k)}−_{L}^{(k)}|≤gap and |μ_{L}^{*(k)}−μ_{L}^{(k)})|≤gap are valid, outputting an optimal road longitudinal slope estimation value λ^{*(k)} under the k^{th} iteration as a final result, if k≤K and |ϑ^{*(k)}−ϑ^{(k)}|≤gap and |λ^{*(k)}−λ^{(k)}|≤gap and |μ_{L}^{*(k)}−μ_{L}^{(k)}|≤gap and |μ_{L}^{*(k)}−μ_{L}^{(k)}|≤gap are not valid, assigning ϑ^{*(k)} to ϑ^{(k+1)}, μ_{L}^{*(k)} to μ_{L}^{(k+1)}, σ_{L}^{*(k)} to σ_{L}^{(k+1)}, λ^{*(k)} to λ^{(k+1)}, and k+1 to k, returning to step 7.3, and sequentially executing.

14. The computer-readable storage medium according to claim 8, wherein step 2 in the road longitudinal slope estimation method based on the unmanned aerial vehicle aerial photography video comprises:
step 2.1, performing a static object recognition on a first frame of picture and a last frame of picture in the traffic flow video respectively, obtaining two frame recognition results and performing a static object matching to obtain a static feature template key;
step 2.2, defining a number of current frames as r, and initializing r=1;
step 2.3, using a FLANN algorithm to match an r^{th} h frame picture in the traffic flow video with a static feature template key to obtain an r^{th} matched feature point set keyᵣ, and using Equation (1) to obtain an r^{th} h perspective transformation matrix Hᵣ;
$$key = {H}_{r} \times {key}_{r} \qquad ( 1 )$$
step 2.4, correcting the r^{th} frame picture with Hᵣ to obtain a corrected r^{th} frame picture; and
step 2.5, assigning r+1 to r, and judging whether r≤M is valid, and if r≤M is valid, returning to step 2.3 for sequential execution; otherwise, it denotes the corrected traffic flow video.

15. The computer-readable storage medium according to claim 14, wherein step 4 in the road longitudinal slope estimation method based on the unmanned aerial vehicle aerial photography video comprises:
step 4.1, acquiring a vehicle trajectory in the grey scale image I via a Canny edge detection algorithm, and after separating the vehicle trajectory from a background, obtaining a binary image A, and letting a set of pixel points with a numerical value of 1 in the binary image A constitute a foreground image B;
step 4.2, after performing corrosion and expansion operations on the foreground image B, obtaining a processed foreground image B₂, and combining the processed foreground image B₂ with the binary image A to form a new binary image A₁;
step 4.3, connecting boundary points of the vehicle trajectory in the binary image A₁ by using an eight-connection criterion to form a processed binary image A₂;
step 4.4, filtering the processed binary image A₂ by using an exponential averaging filter to obtain a noise-reduced binary image A₃;
step 4.5, separating the boundary points of the vehicle trajectory in the noise-reduced binary image A₃ according to a set time threshold value threshold₁, a vehicle length threshold value threshold₂ and a vehicle headway threshold value threshold₃, so as to obtain contour lines of different vehicles in the noise-reduced binary image A₃; and
step 4.6, analyzing the contour lines of different vehicles in the noise-reduced binary image A₃ accurately to obtain the foreground contour of the vehicle as the trajectory data, and according to the entrance and exit order of the vehicle, sorting the trajectory data in an ascending order to obtain the trajectory data set TJ of the vehicle.

16. The computer-readable storage medium according to claim 15, wherein step 5 in the road longitudinal slope estimation method based on the unmanned aerial vehicle aerial photography video comprises:
step 5.1, calculating a distance D₁ between a starting point of the trajectory TJ_{c} of a vehicle c and a starting point of the road, and a distance D₂ between an end point of the trajectory TJ_{c} of the vehicle c and an end point of the road;
step 5.2, judging whether D₁≤threshold₄ is valid, if D₁≤threshold₄ is valid, processing to step 5.3; otherwise, adding the trajectory TJ_{c} of the vehicle c to a lower boundary disconnected trajectory TJ_{down}; wherein threshold₄ denotes a distance threshold between the starting point of the trajectory of the vehicle c and the starting point of the road;
step 5.3, judging whether D₂≤threshold, is valid, if D₂≤threshold, is valid, it indicates that the trajectory TJ_{c} of the vehicle c is a complete trajectory and storing the trajectory TJ_{c} of the vehicle c in a complete trajectory set TJ′; otherwise, adding the trajectory TJ_{c} of the vehicle c to an upper boundary disconnected trajectory TJ₁, wherein threshold denotes a distance threshold between the end point of the trajectory of the vehicle c and the end point of the road;
step 5.4, processing the trajectories of different vehicles in the noise-reduced binary image A₃ according to the process of steps 5.1-5.3, so as to obtain a final lower boundary disconnected trajectory TJ_{down} and a final upper boundary disconnected trajectory TJ up;
step 5.5, calculating a difference D₃ between the end point of the trajectory of any lower boundary disconnected trajectory TJ_{down} and the starting point of the trajectory of any upper boundary disconnected trajectory TJᵤₚ in the time dimension, and a difference D₄ between the end point of the trajectory of the lower boundary disconnected trajectory TJ aow and the starting point of the trajectory of any upper boundary disconnected trajectory TJ″, in the space dimension Z;
step 5.6, judging whether D₃≤threshold, and D₄≤threshold, are valid at the same time, if D₃≤threshold, and D₄≤threshold, are valid at the same time, then entering step 5.7;
otherwise, it indicates that the trajectory TJ_{c} of the vehicle c is a lane-changing trajectory, and is not stored in the complete trajectory set TJ′, wherein threshold, denotes a time headway threshold of the lower boundary disconnected trajectory and the upper boundary disconnected trajectory, and threshold, denotes a space threshold of the lower boundary disconnected trajectory and the upper boundary disconnected trajectory;
step 5.7, connecting a starting point P₀ of the lower boundary disconnected trajectory TJ_{down} with an end point P of the upper boundary disconnected trajectory TJᵤₚ by using a first-order Bessel curve to obtain a missing trajectory TJ₁, and connecting with the upper boundary to form the disconnected trajectory TJᵤₚ and the lower boundary disconnected trajectory TJ_{down} complete trajectory TJ_{c} of the vehicle c, and storing the complete trajectory TJ_{c} of the vehicle c in the complete trajectory set TJ′; and
step 5.8. sorting the complete trajectory set TJ′ in ascending order according to an order of the trajectory, obtaining a sorted complete trajectory set TJ₂, and recording any j^{th} complete trajectory in the sorted complete trajectory set TJ₂ as trajectoryⱼ=[tⱼ, xⱼ], wherein t, is a time series of a j^{th} complete trajectory in the time dimension @, and x, is a position series of the j^{th} complete trajectory in the space dimension Z.

17. The computer-readable storage medium according to claim 16, wherein step 6 in the road longitudinal slope estimation method based on the unmanned aerial vehicle aerial photography video comprises:
step 6.1, calculating an approximate coefficient Tⱼ(a,b) of the j^{th} complete trajectory in the complete trajectory set TJ′ by Equation (2);
$${T}_{j} ( a , b ) = \frac{1}{\sqrt{a}} {\int }_{- ∞}^{∞} {trajectory}_{j} \times [ 1 - {( \frac{{t}_{j} - b}{a} )}^{2} ] {e}^{- \frac{{( \frac{{t}_{j} - b}{a} )}^{2}}{2}} dt \qquad ( 2 )$$
in Equation (2), a is a scale factor, b is a translation factor, b∈tⱼ;
step 6.2, calculating an energy distribution Eⱼ by Equation (3);
$${E}_{j} = \frac{1}{max ( a )} {\int }_{{a}_{min}}^{{a}_{max}} {\vert T ( a , b ) \vert}^{2} da \qquad ( 3 )$$
in Equation (3), aₘᵢₙ denotes a minimum value of the scale factor, aₘₐₓ denotes a maximum value of the scale factor;
step 6.3, computing
$$\frac{\partial {E}_{j}}{\partial b} = 0 ,$$
obtaining a set of speed change point time β={b₁, b₂, . . . , bᵢ, . . . , b_{R}}, wherein bᵢ denotes an i^{th} speed change point time, and R is a number of speed change points;
step 6.4, taking a corresponding speed change point under a condition meets max E_{b}|β={b₁,b₂, . . . , bᵢ} as a core speed change point, so as to obtain a time by, and a position x_{η} corresponding to the core speed change point, and storing a combination [c,b_{η},x_{η}] to the core speed change point set E; and
step 6.5, processing all the complete trajectories according to the process of steps 6.1-6.4, and obtaining the core speed change point set E.

18. The computer-readable storage medium according to claim 17, wherein step 7 in the road longitudinal slope estimation method based on the unmanned aerial vehicle aerial photography video comprises:
step 7.1, according to the position of the core speed change point, combining core speed change points located on an upper road section into a core speed change point set of the upper road section Eᵤₚ, and combining core speed change points located on a lower road section into a core speed change point set of the lower road section E_{down};
using Equation (4) to calculate a reaction time τⱼᵤₚ between a jᵤₚ^{th} core speed change point and a jᵤₚ+1^{th} core speed change point in the core speed change point set of the upper road section Eᵤₚ, so as to obtain a reaction time set τᵤₚ between all adjacent two core speed change points in the core speed change point set of the upper road section Eᵤₚ;
$${τ}_{{j}_{up}} = \vert {t}_{{j}_{up} + 1} - {t}_{{j}_{up}} \vert / fps , {t}_{{j}_{up}} ∈ {E}_{up} \qquad ( 4 )$$
in Equation (4), fps denotes a frame rate of a video;
using Equation (5) to calculate a distance pixel number dⱼ_{ᵤₚ} between the jᵤₚ^{th} core speed change point and the jᵤₚ+1^{th} core speed change point in the core speed change point set of the upper road section Eᵤₚ, so as to obtain a distance pixel number set dᵤₚ between all adjacent two core speed change points in the core speed change point set of the upper road section Eᵤₚ;
$${d}_{{j}_{up}} = \vert {x}_{{j}_{up} + 1} - {x}_{{j}_{up}} \vert , {x}_{{j}_{up}} ∈ {E}_{up} \qquad ( 5 )$$
using Equation (6) to calculate a reaction time τ_{jdown} between a J_{down}^{th} core speed change point and a j_{down}+1^{th} core speed change point in the core speed change point set of the lower road section E_{down}, so as to obtain a reaction time set T_{down} between all adjacent two core speed change points in the core speed change point set of the lower road section E_{down};
$${τ}_{{j}_{down}} = \vert {t}_{{j}_{down} + 1} - {t}_{{j}_{down}} \vert / fps , {t}_{{j}_{down}} ∈ {E}_{down} \qquad ( 6 )$$
using Equation (7) to calculate a distance pixel number d_{jdown} between the j_{down}^{th} core speed change point and the j_{down}+1^{th} core speed change point in the core speed change point set of the lower road section E_{down}, so as to obtain a distance pixel number set d_{down} between all adjacent two core speed change points in the core speed change point set of the lower road section E_{down};
$${d}_{{j}_{down}} = \vert {x}_{{j}_{down} + 1} - {x}_{{j}_{down}} \vert , {x}_{{j}_{down}} ∈ {E}_{down} \qquad ( 7 )$$
combining τᵤₚ and τ_{down} into a time sample data set T, and recording a mean value of the time sample data set T as μ_{τ}, and a standard deviation of the time sample data set T as σ_{τ};
combining dᵤₚ and d_{down} into a distance pixel number sample data set Dis;
step 7.2, defining a maximum number of iterations as K, an error as gap, initializing a current number of iterations k=1, the actual length L of the road pixel in a k^{th} iteration follows, the mean of the actual length of the road pixel is μ_{L}^{(k)}, a standard deviation of the actual length of the road pixel in the k^{th} iteration is a normal distribution N_{L}˜(μ_{L}^{(k)}, σ_{L}^{(k)}) of σ_{L}^{(k)}, and an estimated value λ^{(k)} of the road longitudinal slope in the k^{th} iteration, and an objective function value in the k^{th} iteration is ϑ^{(k)};
step 7.3, using Equation (8), Equation (9) and Equation (10) to respectively obtain a mean value μₛ^{(k)} of an actual headway distance in the k^{th} iteration, a standard deviation σₛ^{(k)} of an actual headway distance in the k^{th} iteration and a covariance ρ^{(k)} in the k^{th} iteration, so as to obtain relevant parameters (μₛ^{(k)}, σₛ^{(k)}, ρ^{(k)}) of the reaction time τ between the core speed change points and the actual headway distance S obeying a bivariate normal distribution N_{(τ,s)} in the k^{th} iteration;
$${μ}_{s}^{( k )} = \frac{\begin{matrix}{\sum }_{{J}_{up} = 1}^{n} {μ}_{L}^{( k )} * {d}_{{j}_{up}}^{( k )} * ( cos ( {λ}^{( k )} ) + \frac{sin {λ}^{( k )}}{tan ( φ - {λ}^{( k )} )} ) + \\ {\sum }_{{J}_{down} = 1}^{m} {μ}_{L}^{( k )} * {d}_{{j}_{down}}^{( k )} * ( \frac{sin φ}{sin ( {λ}^{( k )} + φ )} )\end{matrix}}{n + m - 1} \qquad ( 8 )$$
$${σ}_{s}^{( k )} = \frac{\begin{matrix}\sqrt{{\sum }_{{J}_{up} = 1}^{n} {( {μ}_{L}^{( k )} {d}_{{j}_{up}} * ( cos ( {λ}^{( k )} ) + \frac{sin {λ}^{( k )}}{tan ( φ - {λ}^{( k )} )} ) - {μ}_{d}^{( k )} )}^{2}} + \\ \sqrt{{\sum }_{{J}_{down} = 1}^{m} {( {μ}_{L}^{( k )} {d}_{{j}_{down}} * ( \frac{sin φ}{sin ( {λ}^{( k )} + φ )} ) - {μ}_{d}^{( k )} )}^{2}}\end{matrix}}{n + m - 1} \qquad ( 9 )$$
$${ρ}^{( k )} = \frac{cov ( T , Dis )}{{σ}_{τ} {σ}_{s}^{( k )}} \qquad ( 10 )$$
in Equation (8), Equation (9) and Equation (10), and
$$φ = 90 ° - \frac{γ}{2} ,$$
n is a number of core speed change points in a data set of the upper road section τᵤₚ, m is a number of core speed change points in a data set of the lower road section τ_{down}, and γ denotes a field of view of a camera;
calculating an actual headway distance ωⱼ(λ^{(k)}) under the k^{th} iteration by using Equation (11);
$${ϖ}_{j} ( {λ}^{( k )} ) = \{ \begin{matrix}{d}_{j} * {L}_{i}^{( k )} / 2 * ( cos λ + \frac{sin λ}{tan ( φ - λ )} ) , {d}_{j} ∈ {d}_{up} \\ {d}_{j} * {L}_{i}^{( k )} / 2 * ( \frac{sin φ}{sin ( φ + φ )} ) , {d}_{j} ∈ {d}_{down}\end{matrix} \qquad ( 11 )$$
in Equation (11), dⱼ is j^{th} data of the distance pixel number sample data set Dis;
step 7.4, calculating an actual length value Lᵢ^{(k)} of the i^{th} road pixel under the k^{th} iteration by using Equation (12), and obtaining an actual length value range
$${L}_{sope}^{( k )} = \{ {L}_{i}^{( k )} \vert i ∈ [ \frac{min L}{step} , \frac{max L}{step} ] \}$$
of the road pixel by splicing;
$${L}_{i}^{( k )} = i * step , i ∈ [ \frac{min L}{step} , \frac{max L}{step} ] \qquad ( 12 )$$
in Equation (11), Lk) denotes an i^{th} actual length estimate value of the road pixel under the k^{th} iteration, min L is a minimum value of the actual length of the road pixel, step denotes a step size, and max L denotes a maximum value of the actual length of the road pixel;
step 7.5, obtaining a probability p(L=Lᵢ^{(k)}; μ_{L}^{(k)}, σ_{L}^{(k)}) of the actual length value L=Lᵢ^{(k)} of the road pixel under a μ_{L}^{(k)} and σ_{L}^{(k)} condition in the k^{th} iteration by using Equation (13);
$$p ( L = {L}_{i}^{( k )} ; {μ}_{L}^{( k )} , {σ}_{L}^{( k )} ) = \frac{{\int }_{{L}_{i}^{( k )}}^{{L}_{i}^{( k )} + Δ L} Ω ( L = {L}_{i}^{( k )} ; {μ}_{L}^{( k )} , {σ}_{L}^{( k )} ) d L}{{\int }_{0}^{1} Ω ( L ; {μ}_{L}^{( k )} , {σ}_{L}^{( k )} ) d L} \qquad ( 13 )$$
in Equation (13), ΔL is an increment on Lᵢ^{(k)};
calculating a probability density function Ω(L=Lᵢ^{(k)};μ_{L}^{(k)}, σ^{(k)}) of the actual length value L=Lᵢ^{(k)} of the road pixel under parameter μ_{L}^{(k)} and σ_{L}^{(k)} condition in the k^{th} iteration by using Equation (14);
$$Ω ( L = {L}_{i}^{( k )} ; {μ}_{L}^{( k )} , {σ}_{L}^{( k )} ) = \frac{1}{\sqrt{2 {π ( {σ}_{L}^{( k )} )}^{\hat{} 2}}} {e}^{\frac{- {( {L}_{i}^{( k )} - {μ}_{L}^{( k )} )}^{\hat{} 2}}{2 {( {σ}_{L}^{( k )} )}^{\hat{} 2}}} \qquad ( 14 )$$
step 7.6, using Equation (15) to calculate a conditional probability Qᵢⱼ^{(k)}(L=Lᵢ^{(k)}|τⱼ,dⱼ; μ_{L}^{(k)}, σ_{L}^{(k)}, σ_{L}^{(k)}, λ^{(k)}, μ_{τ}^{(k)}, σ_{τ}^{(k)}, μₛ^{(k)}, ρ(k) of L=Lᵢ^{(k)} taking the j^{th} data τⱼ in the time sample data set T and the j^{th} data dⱼ in the distance pixel number sample data set Dis under parameter μ_{L}^{(k)}, σ_{L}^{(k)}, λ^{(k)}, μ_{τ}, σₛ^{(k)}, ρ^{(k)} in the k^{th} iteration;
$${Q}_{ij}^{( k )} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) = \frac{p ( {τ}_{j} , {d}_{j} , {L}_{i}^{( k )} ; {μ}_{L}^{( k )} , {σ}_{L}^{( k )} , {λ}^{( k )} , {μ}_{τ}^{( k )} , {σ}_{τ}^{( k )} , {μ}_{s}^{( k )} , {σ}_{s}^{( k )} , {ρ}^{( k )} )}{{{\sum }^{R}}_{i = 1} p ( {τ}_{j} , {d}_{j} , {L}_{i}^{( k )} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} )} \qquad ( 15 )$$
in Equation (15), p(τⱼ,dⱼ, Lᵢ^{(k)}; μ_{L}^{(k)}, σ_{L}^{(k)}, λ^{(k)}, μ_{τ}, σ_{τ}, μₛ^{(k)}, σₛ^{(k)}, ρ^{(k)}) denotes a joint probability of simultaneous occurrence of τⱼ, dⱼ, Lᵢ^{(k)} under a given parameter μ_{L}^{(k)}, σ_{L}^{(k)}, λ^{(k)}, μ_{τ}, σ_{τ}, μₛ^{(k)}, σₛ^{(k)}, ρ^{(k)}, and:
$$p ( {τ}_{j} , {d}_{j} , {L}_{i}^{( k )} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) = p ( L = {L}_{i}^{( k )} ; {μ}_{L}^{( k )} , {σ}_{L}^{( k )} ) p ( {τ}_{j} , {d}_{j} \vert {L}_{i}^{( k )} ; {λ}^{( k )} , {μ}_{τ} , {σ}_{τ} , {μ}_{s}^{( k )} , {σ}_{s}^{( k )} , {ρ}^{( k )} ) \qquad ( 16 )$$
calculating a conditional probability p(τⱼ,dⱼ|L=Lᵢ^{(k)}; λ^{(k)}, μ_{τ}, σ_{τ}, μₛ^{(k)}, σₛ^{(k)}, ρ^{(k)}) of τⱼ and dⱼ with the value of L=Lᵢ^{(k)} under the parameter μ_{L}^{(k)}, σ_{L}^{(k)}, λ^{(k)}, μ_{τ}, σ_{τ}, μₛ^{(k)}, σ^{(k)}, ρ^{(k)} in the k^{th} iteration by using Equation (17);
$$p ( {τ}_{j} , {d}_{j} \vert L = {L}_{i}^{( k )} ; {λ}^{( k )} , {μ}_{τ} , {σ}_{τ} , {μ}_{s}^{( k )} , {σ}_{s}^{( k )} , {ρ}^{( k )} ) = {\int }_{{τ}_{j}}^{{τ}_{j} + Δ u} {\int }_{{ϖ}_{j} ( {λ}^{( k )} )}^{{ϖ}_{j} ( {λ}^{( k )} ) + Δ v} \frac{1}{2 {πσ}_{τ}^{( k )} {σ}_{s}^{( k )} \sqrt{1 - {( {ρ}^{( k )} )}^{\hat{} 2}}} {e}^{\frac{- 1}{2 ( 1 - {( {ρ}^{( k )} )}^{\hat{} 2} )} [ {( \frac{{τ}_{j} - {μ}_{τ}^{( k )}}{{σ}_{τ}^{( k )}} )}^{\hat{} 2} + {( \frac{{ϖ}_{j} ( {λ}^{( k )} ) - {μ}_{s}^{( k )}}{{σ}_{s}^{( k )}} )}^{2} - 2 {ρ}^{( k )} ( \frac{{τ}_{j} - {μ}_{τ}^{( k )}}{{σ}_{τ}^{( k )}} ) ( \frac{{ϖ}_{j} ( {λ}^{( k )} ) - {μ}_{s}^{( k )}}{{σ}_{s}^{( k )}} ) ]} dudv \qquad ( 17 )$$
in Equation (17), Δu is an increment on τⱼ, and Δv is an increment on ωⱼ(λ^{(k)});
step 7.7, updating an actual length lⱼ^{(k)} of the road pixels of a j^{th} distance in the k^{th} iteration by using Equation (18);
$${l}_{j}^{( k )} = {\sum }_{i = 1}^{R} {L}_{i} * {Q}_{ij} ( L = {L}_{i}^{( k )} \vert {τ}_{j} , {d}_{j} ; {μ}_{L}^{( k )} , {σ}_{L}^{( k )} , {λ}^{( k )} , {μ}_{τ} , {σ}_{τ} , {μ}_{s}^{( k )} , {σ}_{s}^{( k )} , {ρ}^{( k )} ) \qquad ( 18 )$$
step 7.8, constructing an objective function Λ^{(k)}(θ^{(k)}) in the k^{th} iteration by using Equation (19);
$${Λ}^{( k )} ( {θ}^{( k )} ) = {\sum }_{j}^{J} {Q}_{j} ( L = {l}_{j}^{( k )} \vert {τ}_{j} , {d}_{j} ; {θ}^{( k )} ) log \frac{p ( {τ}_{j} , {d}_{j} , {l}_{j}^{( k )} ; {θ}^{( k )} )}{{Q}_{j} ( L = {l}_{j}^{( k )} \vert {τ}_{j} , {d}_{j} ; {θ}^{( k )} )} \qquad ( 19 )$$
step 7.9, when the objective function Λ^{(k)} (θ^{(k)}) reaches a maximum value, using a least square method to solve an actual length mean value μ_{L}^{*(k)} of an optimal road pixel, an actual length standard deviation σ_{L}^{*(k)} of the optimal road pixel, and an estimated value λ^{*(k)} of an optimal road longitudinal slope in the k^{th} iteration, and an optimal objective function value ϑ^{*(k)}=Λ^{(k)}(θ^{*(k)}); and
step 7.10, judging whether k≤K and |ϑ^{*(k)}−ϑ^{(k)}|≤gap and |λ^{*(k)}−ϑ^{(k)}|≤gap and |μ^{*(k)}−μ_{L}^{(k)}| gap and |μ_{L}^{*(k)}−μ_{L}^{(k)}| gap are simultaneously valid, if k≤K and |ϑ^{*(k)}−ϑ^{(k)}≤gap and |λ^{*(k)}−λ^{(k)}|≤gap and |μ_{L}^{*(k)}−μ_{L}^{(k)}|≤gap and |_{L}^{*(k)}−μₗ^{(k)}≤gap are valid, outputting an optimal road longitudinal slope estimation value λ^{*(k)} under the k^{th} iteration as a final result, if k≤K and |ϑ^{*(k)}−ϑ^{(k)}≤gap and |λ^{*(k)}−λ_{L}^{(k)}|≤gap and |μ_{L}^{*(k)}−μ_{L}^{(k)}|≤gap and |μ_{L}^{*(k)}−μ_{L}^{(k)}|≤gap are not valid, assigning ϑ^{*(k)} to ϑ^{(k+1)}, μ_{L}^{*(k)} to μ_{L}^{(k+1)}, σ^{*(k)} to λ^{(k+1)}, λ^{*(k)} to λ^{(k+1)}, and k+1 to k, returning to step 7.3, and sequentially executing.
